(19) United States
(12) Patent Application Publication
(10) Pub. No.: US 2022/0182188 A1
(43) Pub. Date: Jun. 9, 2022

(54) METHOD AND DEVICE TO TRANSMIT AND RECEIVE HYBRID AUTOMATIC RETRANSMISSION REQUEST ACKNOWLEDGEMENT INFORMATION

(71) Applicant: Samsung Electronics Co., Ltd., Suwon-si (KR)

(72) Inventors: Jingxing FU, Beijing (CN); Feifei SUN, Beijing (CN); Sa ZHANG, Beijing (CN)

(21) Appl. No.: 17/533,356

(22) Filed: Nov. 23, 2021

(30) Foreign Application Priority Data
Dec. 9, 2020 (CN) 202011451569.1
Jan. 15, 2021 (CN) 202110057222.7
May 21, 2021 (CN) 202110559642.5

(51) Int. Cl. H04L 1/18; H04L 5/00

(52) U.S. Cl. CPC H04L 1/1812; H04L 5/0055

(57) ABSTRACT

A method and device for transmitting hybrid automatic retransmission request acknowledgement (HARQ-ACK) information are provided. The method includes receiving control information from a base station, receiving a plurality of pieces of downlink data from the base station, based on the control information, determining, for the plurality of pieces of downlink data, a resource for transmitting HARQ-ACK information, based on the control information, and transmitting the HARQ-ACK information to the base station on the determined resource, wherein determining the resource for transmitting the HARQ-ACK information includes determining, for each of the plurality of pieces of downlink data, a first resource or resource pair for transmitting the HARQ-ACK information, or determining, for the plurality of pieces of downlink data, a second resource or resource pair for transmitting the HARQ-ACK information.

### CROSS-REFERENCE TO RELATED APPLICATION(S)

This application is based on and claims priority under 35 U.S.C. § 119(a) of a Chinese patent application number 202011451569.1, filed on Dec. 9, 2020, in the China National Intellectual Property Administration, and of a Chinese patent application number 202110057222.7, filed on Jan. 15, 2021, in the China National Intellectual Property Administration, and of a Chinese patent application number 202110559642.5, filed on May 21, 2021, in the China National Intellectual Property Administration, the disclosure of each of which is incorporated by reference herein in its entirety.

### BACKGROUND

### 1. Field

The disclosure relates to the field of wireless communication technology. More particularly, the disclosure relates to a method and device to transmit feedback information of hybrid automatic retransmission request acknowledgement (HARQ-ACK), and a communication method, an apparatus, an electronic device, and a computer readable storage medium.

### 2. Description of Related Art

In order to meet the increasing demand for wireless data communication services since the deployment of 4^{th} generation (4G) communication systems, efforts have been made to develop improved 5^{th} generation (5G) or pre-5G communication systems. Therefore, 5G or pre-5G communication systems are also called “Beyond 4G networks” or “Post-long-term evolution (LTE) systems”.

In order to achieve a higher data rate, 5G communication systems are implemented in higher frequency (millimeter wave, (mmWave)) bands, e.g., 60 gigahertz (GHz) bands. In order to reduce propagation loss of radio waves and increase a transmission distance, technologies, such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, or the like.

In 5G systems, hybrid frequency shift keying (FSK) and quadrature amplitude modulation (QAM) frequency shift keying quadrature amplitude modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method for transmitting feedback information of HARQ-ACK, for example, a method for transmitting HARQ-ACK for the physical downlink shared channel (PDSCH).

Additional aspects will be set forth in part in the description which follows and, in part, will be apparent from the description, or may be learned by practice of the presented embodiments.

In order to achieve the above-mentioned objectives, the disclosure adopts the following solutions.

In accordance with an aspect of the disclosure, a method performed by a user equipment in a wireless communication system is provided. The method includes receiving control information from a base station, receiving a plurality of pieces of downlink data from the base station, based on the control information, determining, for the plurality of pieces of downlink data, a resource for transmitting hybrid automatic retransmission request acknowledgement (HARQ-ACK) information, based on the control information, and transmitting the HARQ-ACK information to the base station on the determined resource, wherein determining the resource for transmitting the HARQ-ACK information includes determining, for each of the plurality of pieces of downlink data, a first resource or resource pair for transmitting the HARQ-ACK information, or determining, for the plurality of pieces of downlink data, a second resource or resource pair for transmitting the HARQ-ACK information.

According to an embodiment of the disclosure, in the case of determining the second resource or resource pair for transmitting the HARQ-ACK information, the user equipment bundles the HARQ-ACK information for the plurality of pieces of downlink data and transmits the bundled HARQ-ACK information on the determined second resource or resource pair.

According to an embodiment of the disclosure, in the case of determining the second resource or resource pair for transmitting the HARQ-ACK information, the user equipment bundles the HARQ-ACK information for the plurality of pieces of downlink data and transmits the bundled HARQ-ACK information on the determined second resource or resource pair.

According to an embodiment of the disclosure, the second resource or resource pair for transmitting the HARQ-ACK information is determined based on a predetermined rule.

According to an embodiment of the disclosure, the second resource or resource pair for transmitting the HARQ-ACK information is selected from a set of resources for transmitting the HARQ-ACK information.

According to an embodiment of the disclosure, if the bundled HARQ-ACK information is a negative acknowledgement NACK, the bundled HARQ-ACK information is transmitted on the determined second resource, and if the bundled HARQ-ACK information is an acknowledgement ACK, the bundled HARQ-ACK information is not transmitted, or if the bundled HARQ-ACK information is NACK, the bundled HARQ-ACK information is transmitted on one resource in the determined second resource pair, and if the bundled HARQ-ACK information is ACK, the bundled HARQ-ACK information is transmitted on the other resource in the determined second resource pair.

According to an embodiment of the disclosure, the predetermined rule may include the following HARQ-ACK information for only one piece of downlink data among the plurality of pieces of downlink data is a negative acknowledgement NACK, a resource or resource pair corresponding to the HARQ-ACK information for the piece of downlink data is determined as the second resource or resource pair; and when there is more than one piece of downlink data for which HARQ-ACK information is NACK among the plurality of pieces of downlink data, a resource or resource pair corresponding to one of the more than one piece of downlink data is determined as the second resource or resource pair.

According to an embodiment of the disclosure, determining the resource or resource pair corresponding to one of the more than one piece of downlink data as the second resource or resource pair includes determining a resource or resource pair corresponding to a chronologically first or last downlink data of the more than one piece of downlink data as the second resource or resource pair.

According to an embodiment of the disclosure, the set of resources for transmitting HARQ-ACK information is determined based on a semi-static resource set determination approach or a dynamic resource set determination approach.

According to an embodiment of the disclosure, in the case of determining the first resource or resource pair for transmitting the HARQ-ACK information, the first resource or resource pair is determined based on information related to uplink resources included in the control information, or the first resource or resource pair is determined based on information related to uplink resources and information related to downlink allocation included in the control information.

According to an embodiment of the disclosure, in the case of determining the first resource or resource pair for transmitting the HARQ-ACK information, for each piece of downlink data if the HARQ-ACK information is a negative acknowledgement NACK, the HARQ-ACK information is transmitted on the determined first resource, and if the HARQ-ACK information is an acknowledgement ACK, the HARQ-ACK information is not transmitted, or if the HARQ-ACK information is NACK, the HARQ-ACK information is transmitted on one resource in the determined first resource pair, and if the HARQ-ACK information is ACK, the HARQ-ACK information is transmitted on the other resource in the determined first resource pair.

According to an embodiment of the disclosure, the user equipment and at least one other user equipment use the same first resource or resource pair or second resource or resource pair to transmit the HARQ-ACK information for the same downlink data.

In accordance with another aspect of the disclosure, a method performed by a base station in a wireless communication system is provided. The method includes transmitting control information to a user equipment, transmitting a plurality of pieces of downlink data to the user equipment, based on the control information, and receiving hybrid automatic retransmission request acknowledgement (HARQ-ACK) information from the user equipment on a resource for receiving the HARQ-ACK information, wherein the resource is determined for the plurality of pieces of downlink data, based on the control information, and includes a first resource or resource pair for transmitting the HARQ-ACK information determined for each of the plurality of pieces of downlink data, or a second resource or resource pair for transmitting the HARQ-ACK information determined for the plurality of pieces of downlink data.

In accordance with another aspect of the disclosure, a user equipment in a wireless communication system is provided. The user equipment includes a memory in which instructions are stored, and a processor configured to execute the instructions to implement the foregoing method for transmitting the HARQ.

In accordance with another aspect of the disclosure, a base station in a wireless communication system is provided. The base station includes a memory in which instructions are stored, and a processor configured to execute the instructions to implement the foregoing method for receiving the HARQ. Further, in the disclosure, a method of transmitting HARQ-ACK for the PDSCH is described, such that the HARQ-ACK feedback information for the PDSCH could be accurately transmitted with as few PUCCH resources as possible on the premise that the multicast and unicast technologies could save the PDSCH and the PDCCH.

The disclosure provides a communication method, an apparatus, an electronic device, and a computer-readable storage medium. The solutions are as follows.

In accordance with another aspect of the disclosure, a method performed by a user equipment (UE) in a communication system is provided. The method includes acquiring first information for activating detection of a first type of physical downlink control channel (PDCCH), detecting the first type of PDCCH, and receiving a first type of physical downlink shared channel (PDSCH) according to the first type of PDCCH, and/or acquiring second information for stopping detecting the first type of PDCCH, stopping detecting the first type of PDCCH.

According to an embodiment of the disclosure, the first information includes at least one of the following activation indication, configuration information for detecting the first type of PDCCH, configuration information for receiving the first type of PDSCH.

The first information includes at least one of the following activation indication, configuration information for detecting the first type of PDCCH, configuration information for receiving the first type of PDSCH.

The detecting the first type of PDCCH includes at least one of the following when the activation indication is a first preset value, detecting the first type of PDCCH, when the activation indication is a second preset value, determining a corresponding information block in the first information, and determining whether to detect the first type of PDCCH according to the activation indication in the information block.

The detecting the first type of PDCCH includes when there are at least two sets of configurations for detecting the first type of PDCCH, determining a configuration for detecting the first type of PDCCH to be used according to the configuration information for detecting the first type of PDCCH, and detecting the first type of PDCCH according to the determined configuration for detecting the first type of PDCCH.

A number of bits of the configuration information for detecting the first type of PDCCH is determined according to a number of configurations for detecting the first type of PDCCH.

When the first information is higher layer signaling, the detecting the first type of PDCCH includes when there are at least two sets of configurations for detecting the first type of PDCCH, detecting the first type of PDCCH according to a configuration for detecting the first type of PDCCH indicated by the higher layer signaling.

The configuration information for detecting the first type of PDCCH and receiving the first type of PDSCH includes at least one of the following a serving cell in which the first type of PDCCH is detected and the first type of PDSCH is received, downlink bandwidth part BWP in which the first type of PDCCH is detected and the first type of PDSCH is received, a frequency domain position of a resource for detecting the first type of PDCCH and receiving the first type of PDSCH in the downlink BWP, configuration information for a control resource set for detecting the first type of PDCCH, configuration information for a search space for detecting the first type of PDCCH, configuration information for receiving the first type of PDSCH.

The detecting the first type of PDCCH includes at least one of the following, if the serving cell in which the first type of PDCCH is detected and the first type of PDSCH is received is an activated serving cell, and an activated BWP A in the activated serving cell is the BWP in which the first type of PDCCH is detected and the first type of PDSCH is received, detecting the first type of PDCCH in a first PDCCH search space in the activated BWP A, if the serving cell in which the first type of PDCCH is detected and the first type of PDSCH is received is an activated serving cell, but an activated BWP A in the activated serving cell is not the BWP in which the first type of PDCCH is detected and the first type of PDSCH is received, switching from the currently activated BWP A to BWP B in which the first type of PDCCH is detected and the first type of PDSCH is received, and detecting the first type of PDCCH in the activated BWP B, if the serving cell in which the first type of PDCCH is detected and the first type of PDSCH is received is a non-activated serving cell, activating the serving cell, and activating BWP B in which the first type of PDCCH is detected and the first type of PDSCH is received, and detecting the first type of PDCCH in the activated BWP B.

When detecting the first type of PDCCH in the activated BWP B, the method further includes at least one of the following, if detecting a second type of PDCCH and receiving a second type of PDSCH is configured in the BWP B, detecting the second type of PDCCH in the activated BWP B, if the activated BWP A in the activated serving cell and the BWP B in which the first type of PDCCH is detected and the first type of PDSCH is received are a BWP pair, and the activated BWP B is contained in the activated BWP A, detecting the second type of PDCCH in a second PDCCH search space in the activated BWP A.

The second information includes a stop indication, and the stopping detecting the first type of PDCCH includes at least one of the following, when the stop indication is a third preset value, stopping detecting the first type of PDCCH, when the stop indication is a fourth preset value, determining a corresponding information block in the second information, and determining whether to stop detecting the first type of PDCCH according to the stop indication in the information block.

After the stopping detecting the first type of PDCCH, the method further includes at least one of the following, if the second type of PDCCH needs to be detected, detecting the second type of PDCCH in the second PDCCH search space in the currently activated BWP, if there is no need to detect the second type of PDCCH, switching the BWP in the serving cell in which the first type of PDCCH is detected and the first type of PDSCH is received to a default BWP, or changing the serving cell in which the first type of PDCCH is detected and the first type of PDSCH is received to a non-activated serving cell.

The detecting the first type of PDCCH includes determining a second slot in which the first type of PDCCH is detected according to a first timing relationship and a first slot in which the first information is received, detecting the first type of PDCCH in the second slot.

The stopping detecting the first type of PDCCH includes determining a fourth slot in which detecting the first type of PDCCH is stopped, according to a second timing relationship and a third slot in which the second information is received, stopping detecting the first type of PDCCH in the fourth slot.

The first timing relationship is determined according to whether the serving cell in which the first type of PDCCH is detected is in an activated state and/or whether the BWP in which the first type of PDCCH is detected is an activated BWP.

The second timing relationship is determined according to an information type of the second information.

When the first information or the second information corresponds to at least two terminals, it further includes when a state in which the first type of PDCCH is detected is changed, feeding back the HARQ-ACK for the first information or the second information, when the state in which the first type of PDCCH is detected is not changed, not feeding back the HARQ-ACK for the first information or the second information.

When there are at least two BWPs in which the first type of search space is included, and the frequency domain range of the first BWP currently located is larger than the frequency domain range of other BWPs, the method further includes at least one of the following, if a first timer for counting of the reception of the first type of PDSCH does not expire, and a second timer for counting of the reception of the second type of PDSCH expires, switching from the first BWP to another BWP, and detecting the first type of PDCCH in the switched-to BWP, if both the first timer and the second timer expire, switching to a default BWP or an initial BWP, and if the first timer expires and the second timer does not expire, stopping detecting the first type of PDCCH, or stopping detecting the first type of PDCCH in the first type of search space.

When the BWP is switched, it further includes at least one of the following, when the first type of search space for detecting the first type of PDCCH is included in the BWP before being switched, and the state in which the first type of PDCCH is detected is activated, if the first type of search space is included in the switched-to BWP, activating the detection of the first type of PDCCH in the switched-to BWP, and if the first type of search space is not included in the switched-to BWP, not detecting the first type of PDCCH in the switched-to BWP, when the BWP before being switched and the BWP specific to the first type of PDCCH are a pair, and both are in the activated state, if the switched-to BWP and the BWP specific to the first type of PDCCH are a pair, changing the BWP specific to the first type of PDCCH paired with the switched-to BWP to the activated state, and if the switched-to BWP is not a pair with the BWP specific to the first type of PDCCH, not detecting the first type of PDCCH after the BWP is switched.

When the first type of PDCCH is not detected in the switched-to BWP, the method further includes at least one of the following, the state in which the first type of PDCCH is detected being the activated state, if it is further switched to a new BWP in which the first type of search space is included, the first type of PDCCH is detected in the new BWP, the state in which the first type of PDCCH is detected being the stopped state, if it is further switched to a new BWP in which the first type of search space is included, when there is no new activation indication, the first type of PDCCH is not detected in the new BWP.

When not detecting the first type of PDCCH after the BWP is switched, the method includes at least one of the following, the state in which the first type of PDCCH is detected being the activated state, if it is further switched to a third BWP in which the second type of PDCCH is detected, and the third BWP is a pair with the fourth BWP in which the first type of PDCCH is detected, the first type of PDCCH is detected in the fourth BWP, the state in which the first type of PDCCH is detected being the stopped state, if it is further switched to the third BWP in which the second type of PDCCH is detected, and the third BWP is a pair with the fourth BWP in which the first type of PDCCH is detected, when there is no new activation indication, the first type of PDCCH is not detected in the fourth BWP.

The first type of PDCCH is a groupcast/multicast PDCCH, and the second type of PDCCH is a unicast PDCCH.

In accordance with another aspect of the disclosure, a communication apparatus is provided. The communication apparatus includes a first acquiring module for acquiring first information for activating detection of a first type of PDCCH, a detecting and receiving module for detecting the first type of PDCCH, and receive the first type of PDSCH according to the first type of PDCCH, and/or a second acquiring module for acquiring second information for stopping the detection of the first type of PDCCH, a stopping module for stopping detecting the first type of PDCCH.

In accordance with another aspect of the an electronic device is provided. The electronic device includes a processor and a memory, the memory storing at least one instruction, at least one segment of program, code set, or instruction set, the at least one instruction, at least one segment of program, code set or instruction set is loaded and executed by the processor to implement the method illustrated in the first aspect of the disclosure.

In accordance with another aspect of the disclosure, a computer-readable storage medium is provided. The computer-readable storage medium includes storing an computer instructions, a program, a code set, or an instruction set, which, when being executed by a computer, cause the computer to perform the method illustrated in the first aspect of the disclosure.

The communication method, apparatus, electronic device, and computer-readable storage medium provided in the disclosure can effectively start and/or end reception of PDSCH.

Other aspects, advantages, and salient features of the disclosure will become apparent to those skilled in the art from the following detailed description, which, taken in conjunction with the annexed drawings, discloses various embodiments of the disclosure

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a wireless network according to an embodiment of the disclosure;

FIGS. 2A and 2B illustrate a wireless transmission and reception paths according to various embodiments of the disclosure;

FIG. 3A illustrates a user equipment (UE) according to an embodiment of the disclosure;

FIG. 3B illustrates a gNodeB (gNB) according to an embodiment of the disclosure;

FIG. 4 illustrates a flowchart of a method according to an embodiment of the disclosure;

FIG. 5 illustrates a schematic diagram of transmitting hybrid automatic retransmission request acknowledgement (HARQ-ACK) information according to an embodiment of the disclosure;

FIG. 6 illustrates a schematic diagram of transmitting HARQ-ACK information according to an embodiment of the disclosure;

FIG. 7 illustrates a schematic diagram of transmitting HARQ-ACK information according to an embodiment of the disclosure;

FIG. 8 illustrates a schematic diagram of transmitting HARQ-ACK information according to an embodiment of the disclosure;

FIG. 9 illustrates a block diagram of a UE according to an embodiment of the disclosure;

FIG. 10 illustrates a block diagram of a base station according to an embodiment of the disclosure;

FIG. 11 is a schematic flowchart of a communication method according to an embodiment of the disclosure;

FIG. 12 is a schematic flowchart of a communication method according to an embodiment of the disclosure;

FIG. 13 is a schematic diagram of a flowchart of detecting a first type of physical downlink control channel (PDCCH) and receiving a first type of physical downlink shared channel (PDSCH) according to an embodiment of the disclosure;

FIG. 14 is a schematic diagram of a scenario in which a first type of PDCCH is detected and a first type of PDSCH is received according to an embodiment of the disclosure;

FIG. 15 is a schematic diagram of a scenario in which a first type of PDCCH is detected and a first type of PDSCH is received according to an embodiment of the disclosure;

FIG. 16 is a schematic diagram of a scenario in which a first type of PDCCH is detected and a first type of PDSCH is received according to an embodiment of the disclosure;

FIG. 17 is a schematic diagram of stopping detecting a first type of PDCCH and receiving a first type of PDSCH according to timer expiration according to an embodiment of the disclosure;

FIG. 18 is a schematic diagram after stopping detecting a first type of PDCCH and receiving a first type of PDSCH according to an embodiment of the disclosure;

FIG. 19 is a schematic diagram of switching a band width part (BWP) according to an embodiment of the disclosure;

FIG. 20 is a schematic structural diagram of a communication apparatus according to an embodiment of the disclosure; and

FIG. 21 is a schematic structural diagram of a communication apparatus according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Those skilled in the art can understand that, unless specifically stated, the singular forms “a”, “an”, “said” and “the” used herein may also include plural forms. It should be further understood that the term “comprising” used in the specification of this application means the presence of the described features, integers, operations, elements and/or components, but does not exclude the presence or addition of one or more other features, integers, operations, elements, components, and/or combinations thereof. It should be understood that when an element is referred to as being “connected” or “coupled” to other element, it can be directly connected or coupled to the other element, or intervening elements may also be present. In addition, “connected” or “coupled” used herein may include wireless connection or wireless coupling. The term “and/or” as used herein includes all or any unit and all combinations of one or more associated listed items.

In order to make the objectives, solutions, and advantages of the application more evident, the application will be further described below with reference to the accompanying drawings and embodiments.

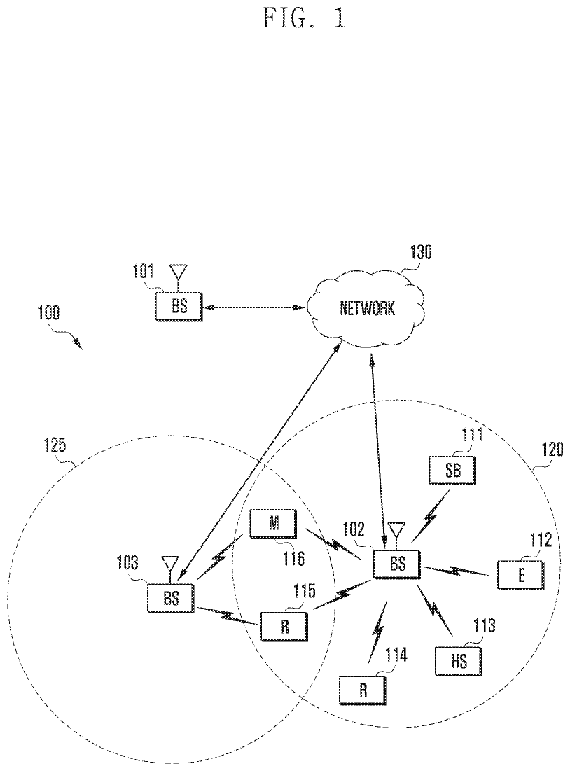

FIG. 1 illustrates a wireless network according to an embodiment of the disclosure. The embodiment of the wireless network 100 shown in FIG. 1 is for illustration only. Other embodiments of the wireless network 100 can be used without departing from the scope of the disclosure.

Referring to FIG. 1, a wireless network 100 comprises a gNodeB (gNB) 101, a gNB 102, and a gNB 103. gNB 101 communicates with gNB 102 and gNB 103. gNB 101 also communicates with at least one Internet protocol (IP) network 130, such as the Internet, a private IP network, or other data networks.

Depending on a type of the network, other well-known terms, such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms, such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of user equipment (UEs) within a coverage area 120 of gNB 102. The first plurality of UEs include a UE 111, which may be located in a small business (SB), a UE 112, which may be located in an enterprise (E), a UE 113, which may be located in a WiFi Hotspot (HS), a UE 114, which may be located in a first residence (R), a UE 115, which may be located in a second residence (R), a UE 116, which may be a mobile device (M), such as a cellular phone, a wireless laptop computer, a wireless PDA, or the like. GNB 103 provides wireless broadband access to network 130 for a second plurality of UEs within a coverage area 125 of gNB 103. The second plurality of UEs include a UE 115 and a UE 116. In some embodiments of the disclosure, one or more of gNBs 101-103 can communicate with each other and with UEs 111-116 using 5G, long term evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described below, one or more of gNB 101, gNB 102, and gNB 103 include a two dimensional (2D) antenna array as described in embodiments of the disclosure. In some embodiments of the disclosure, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

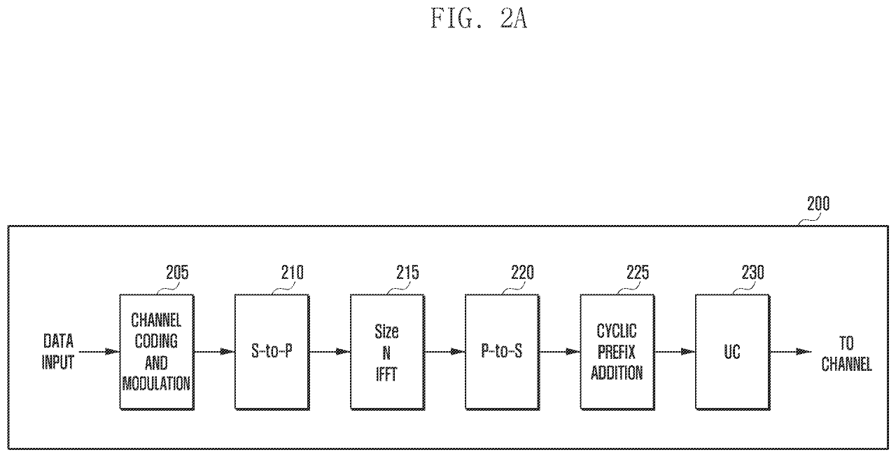

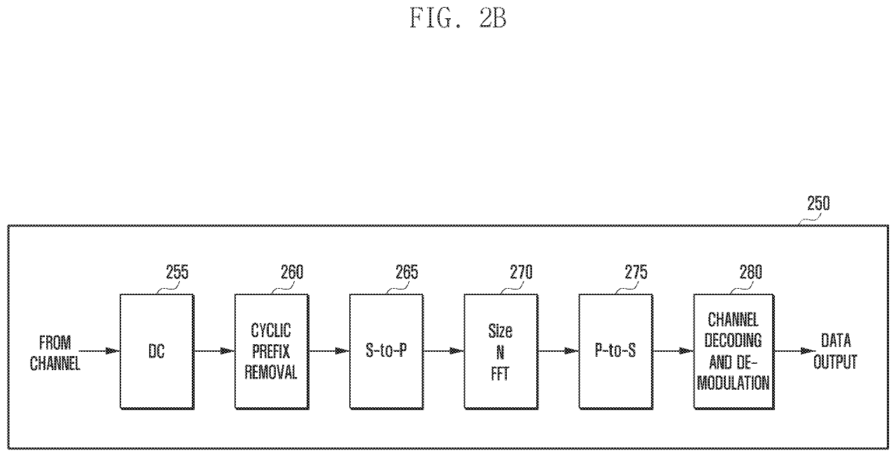

FIGS. 2A and 2B illustrate a wireless transmission and reception paths according various embodiments of the disclosure.

Referring to FIG. 2A, in the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments of the disclosure, the reception path 250 is configured to support codebook designs and structures for systems with 2D antenna arrays as described in embodiments of the disclosure.

The transmission path 200 comprises a channel coding and modulation block 205, a serial-to-parallel (S-to-P) block 210, a size N inverse fast Fourier transform (IFFT) block 215, a parallel-to-serial (P-to-S) block 220, a cyclic prefix addition block 225, and an up-converter (UC) 230. Referring to FIG. 2B, the reception path 250 comprises a down-converter (DC) 255, a cyclic prefix removal block 260, a S-to-P block 265, a size N FFT block 270, a P-to-S block 275, and a channel decoding and demodulation block 280.

In the transmission path 200, the channel coding and modulation block 205 receives a set of information bits, applies coding (such as low density parity check (LDPC) coding), and modulates the input bits (such as using quadrature phase shift keying (QPSK) or quadrature amplitude modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as discrete Fourier transform (DFT) and inverse discrete Fourier transform (IDFT) functions. It should be understood that for DFT and IDFT functions, the value of variable N may be any integer (such as 1, 2, 3, 4, or the like), while for FFT and IFFT functions, the value of variable N may be any integer which is a power of 2 (such as 1, 2, 4, 8, 16, or the like).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

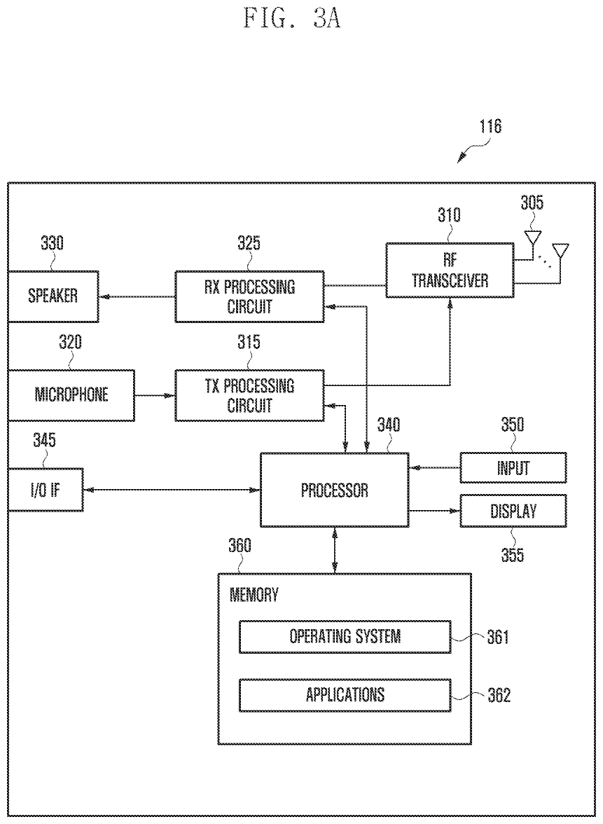

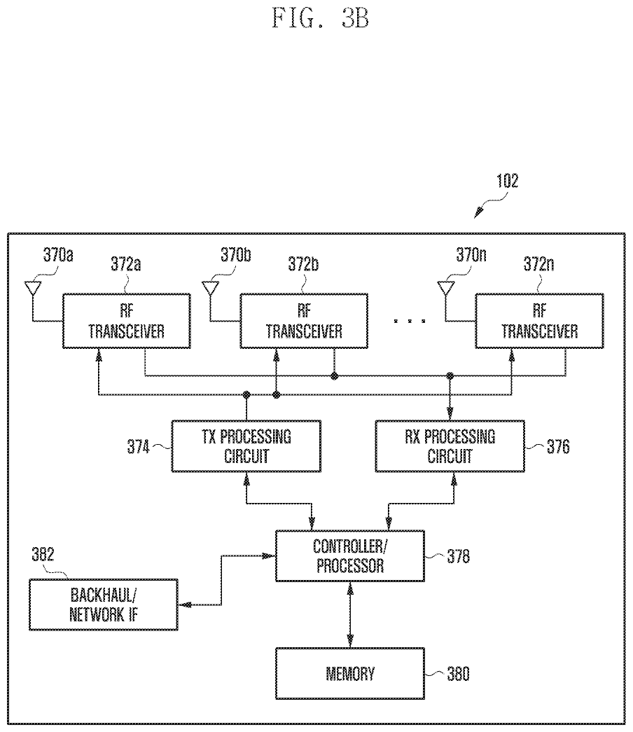

FIG. 3A illustrates a UE 116 according to an embodiment of the disclosure. The embodiment of UE 116 shown in FIG. 3A is for illustration only, and UEs 111-115 of FIG. 1 can have the same or similar configuration. However, a UE has various configurations, and FIG. 3A does not limit the scope of the disclosure to any specific implementation of the UE.

Referring to FIG. 3A, the UE 116 comprises an antenna 305, a radio frequency (RF) transceiver 310, a transmission (TX) processing circuit 315, a microphone 320, and a reception (RX) processing circuit 325. UE 116 also comprises a speaker 330, a processor/controller 340, an input/output (I/O) interface 345, an input device(s) 350, a display 355, and a memory 360. The memory 360 comprises an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments of the disclosure, the processor/controller 340 comprises at least one microprocessor or microcontroller.

The processor/controller 340 is also capable of executing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In some embodiments of the disclosure, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices, such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to an embodiment of the disclosure. The embodiment of gNB 102 shown in FIG. 3B is for illustration only, and other gNBs of FIG. 1 can have the same or similar configuration. However, a gNB has various configurations, and FIG. 3B does not limit the scope of the disclosure to any specific implementation of a gNB. It should be noted that gNB 101 and gNB 103 can include the same or similar structures as gNB 102.

Referring to FIG. 3B, gNB 102 comprises a plurality of antennas 370a-370n, a plurality of RF transceivers 372a-372n, a transmission (TX) processing circuit 374, and a reception (RX) processing circuit 376. In certain embodiments of the disclosure, one or more of the plurality of antennas 370a-370n include a 2D antenna array. gNB 102 also comprises a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-layer wireless communication functions. For example, the controller/processor 378 can perform a blind interference sensing (BIS) process such as that performed through a BIS algorithm, and decode a received signal from which an interference signal is subtracted. A controller/processor 378 may support any of a variety of other functions in gNB 102. In some embodiments of the disclosure, the controller/processor 378 comprises at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some embodiments of the disclosure, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 comprises any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments of the disclosure, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

The various embodiments of the disclosure are further described below with reference to the accompanying drawings.

The text and drawings are provided as examples only to help readers understand the disclosure. They are not intended and should not be construed as limiting the scope of the disclosure in any way. While certain embodiments and examples have been provided, based on the content disclosed herein, it is obvious to those skilled in the art that the embodiments and examples shown can be modified without departing from the scope of the disclosure.

The transmission from a base station to a user equipment (UE) is called downlink, and different physical channels are defined: physical downlink shared channel (PDSCH), which is used to transmit traffic data, and may also transmit singling, and PDCCH, which may carry resource allocation information for paging and user data, as well as HARQ information related to user data. The transmission from the UE to the base station is called uplink. The HARQ-ACK information for the PDSCH may be transmitted on the physical uplink shared channel (PUSCH) or the physical uplink control channel (PUCCH). The PDSCH is scheduled by downlink control information (DCI) transmitted by the physical downlink control channel (PDCCH).

For PDSCH transmission, transmission mechanisms, such as Unicast, Groupcast or Multicast, or Broadcast can be used. The unicast PDSCH is a PDSCH received by a UE. Preferably, the scrambling of the unicast PDSCH is based on the UE-specific radio network temporary indicator (RNTI), such as C-RNTI. Groupcast/broadcast is a PDSCH received by more than one UE at the same time. Compared with unicast PDSCH, groupcast/broadcast can effectively improve communication efficiency. However, the current transmission mode still needs to be improved.

It is required to provide a technology for transmitting HARQ-ACK for groupcast or multicast/broadcast PDSCH.

Hereafter, description is made taking the HARQ-ACK information for the PDSCH transmitted on the PUCCH as an example. However, those skilled in the art should understand that the HARQ-ACK information for the PDSCH may also be transmitted on the PUSCH, or the HARQ-ACK information for the PDSCH may transmitted on physical random access channel (PRACH). The scheme described hereafter taking the PUCCH as an example is also applicable to PUSCH and PRACH.

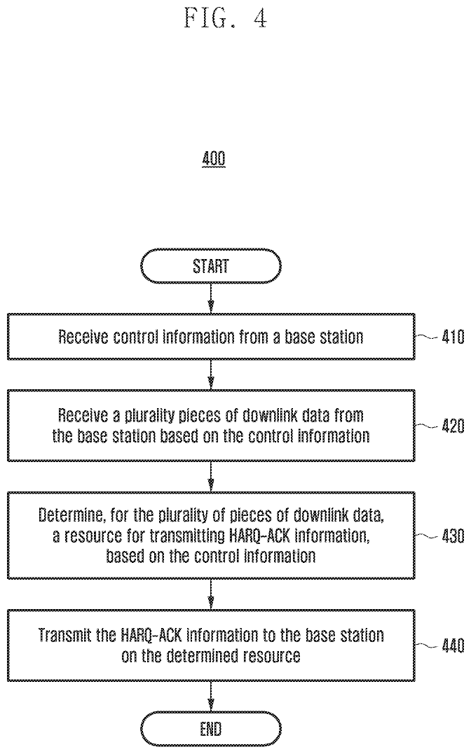

FIG. 4 illustrates a flowchart of a method 400 according to an embodiment of the disclosure. The example method 400 of FIG. 4 may be used to transmit Hybrid Automatic Retransmission Request Acknowledge HARQ-ACK information. The method 400 can be implemented on the UE side.

Referring to FIG. 4, in operation S410 of the method 400, control information is received from a base station. For example, the control information may be downlink control information (DCI).

In operation S420, a plurality of pieces of downlink data is received based on the control information. For example, the downlink data may be PDSCH. The control information may include a field related to the transmission of downlink data, and the UE may receive the plurality of pieces of downlink data based on information indicated by the related field in the control information.

In operation S430, a resource for transmitting HARQ-ACK is determined for the plurality of pieces of downlink data, based on the control information.

According to an embodiment of the disclosure, determining the resource for transmitting the HARQ-ACK information includes: determining, for each of the plurality of pieces of downlink data, a first resource or resource pair for transmitting the HARQ-ACK information; or determining, for the plurality of pieces of downlink data, a second resource or resource pair for transmitting the HARQ-ACK information.

According to an embodiment of the disclosure, the PUCCH resource for transmitting the HARQ-ACK information may be indicated by a PUCCH resource indicator (PRI) field in the DCI.

In operation S440, the HARQ-ACK information is transmitted to the base station on the determined resource.

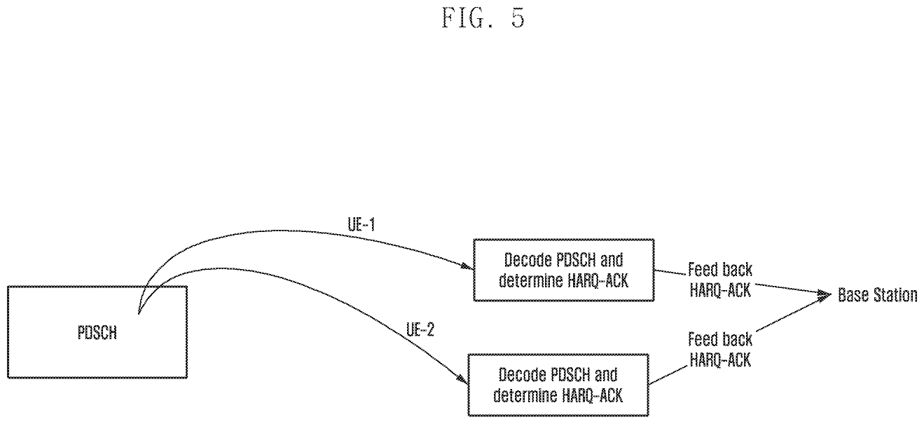

FIG. 5 illustrates a schematic diagram of transmitting HARQ-ACK information according to an embodiment of the disclosure.

The PDSCH as the downlink data may be a groupcast/multicast PDSCH or a broadcast PDSCH, that is, the same PDSCH may be received by more than one UE. Referring to FIG. 5, two user equipment UE-1 and UE-2 receive the same PDSCH, determine the HARQ-ACK information respectively according to whether their respective PDSCH decoding is correct or not, and feedback their respective HARQ-ACK information to the base station respectively. However, the PDSCH is not limited to groupcast/multicast PDSCH and broadcast PDSCH.

According to an embodiment of the disclosure, if the UEs decode the PDSCH correctly, the UEs do not feedback HARQ-ACK information, and if the UEs receive the PDCCH but do not decode the PDSCH correctly, the UEs feedback NACK on the PUCCH resource.

According to an embodiment of the disclosure, if the UEs decode the PDSCH correctly, the UEs feedback ACK on the PUCCH resource, and if the UEs receive the PDCCH but do not decode the PDSCH correctly, the UEs feedback NACK on the PUCCH resource.

What is described above is the processing method when the UEs need to feedback the HARQ-ACK information for one or more PDSCHs in a slot.

According to an embodiment of the disclosure, the UE and at least one other user equipment may use the same resource or resource pair to transmit the HARQ-ACK information for the same downlink data.

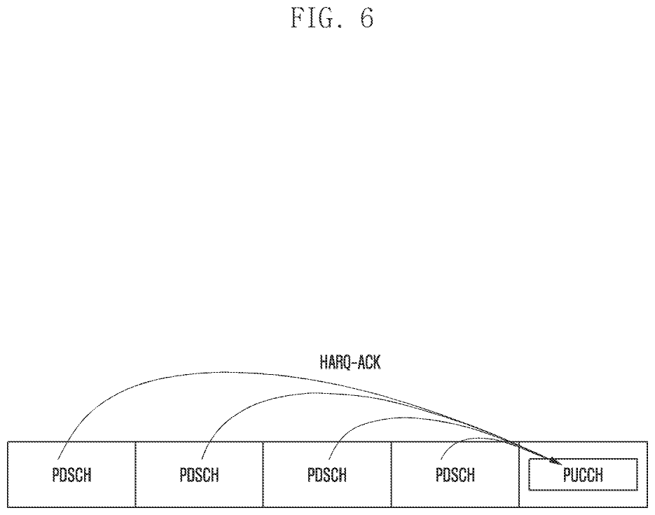

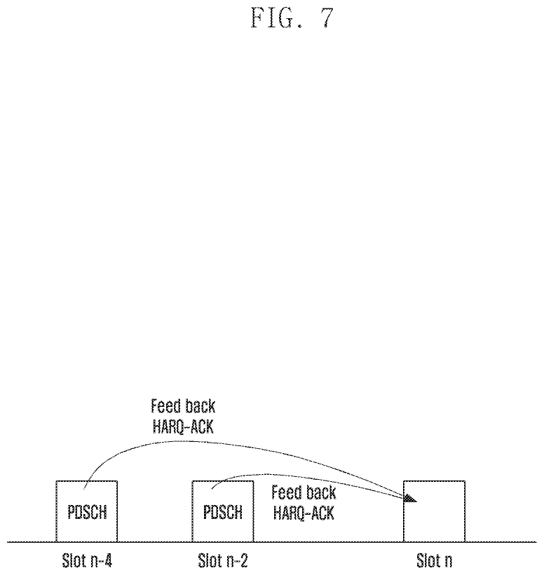

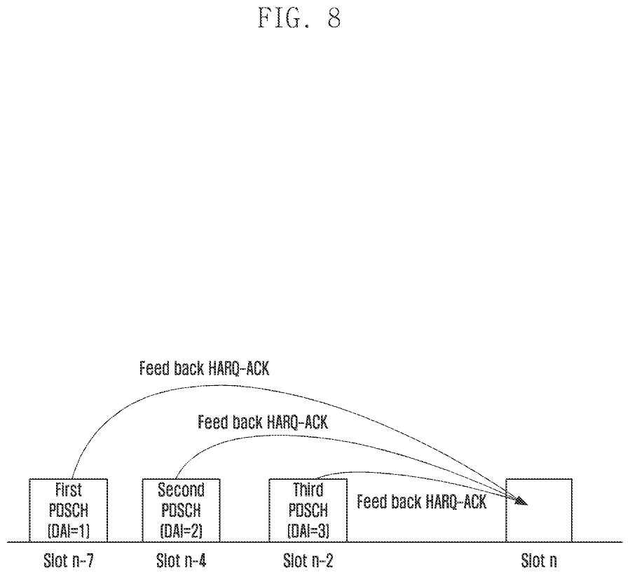

FIG. 6 illustrates a schematic diagram of transmitting HARQ-ACK information according to an embodiment of the disclosure. FIG. 7 illustrates a schematic diagram of transmitting HARQ-ACK information according to an embodiment of the disclosure. FIG. 8 illustrates a schematic diagram of transmitting HARQ-ACK information according to an embodiment of the disclosure.

Referring to FIGS. 6-8, when the UE wants to feedback the HARQ-ACK information for more than one PDSCH in a slot, an embodiment of its processing method is described below referring to FIG. 6.

### Embodiment 1

For the HARQ-ACK information for each PDSCH of the multiple PDSCHs received by the UE, the UE uses independent PUCCH resources to transmit it separately. The independent PUCCH resources may be time-division resources, code-division resources, frequency-division resources, or combined resources of time-division resources, code division resources, and frequency division resources, that is, the independent PUCCH resources are orthogonal to each other. The HARQ-ACK information for different PDSCHs received by the UE may be simultaneously transmitted on different PUCCH resources. For example, the UE receives 2 PDSCHs in 2 slots, the HARQ-ACK information for the 2 PDSCHs is transmitted on the PUCCH at a slot n, the HARQ-ACK information for PDSCH-1 is transmitted on PUCCH-1, and the HARQ-ACK information for PDSCH-2 is transmitted on PUCCH-2, referring to FIG. 7. The PUCCH-1 is transmitted on OFDM symbol 1 and OFDM symbol 2 of slot n, the PUCCH-2 is transmitted on OFDM symbol 4 and OFDM symbol 5 of slot n, wherein PUCCH-1 and PUCCH-2 do not overlap in time. Alternatively, the PUCCH-1 is transmitted on OFDM symbol 1 and OFDM symbol 2 of slot n, PUCCH-2 is transmitted on OFDM symbol 2 and OFDM symbol 3 of slot n, wherein PUCCH-1 and PUCCH-2 overlap in time, and the PUCCH-1 and PUCCH-2 occupy different physical resource blocks (PRB), that is, the PUCCH-1 and PUCCH-2 do not overlap in the frequency domain. Alternatively, the PUCCH-1 and PUCCH-2 overlap in the frequency domain, but the PUCCH-1 and PUCCH-2 use different cyclic shifts (CSs). The above uses multiple PUCCH resources, or different signal sequences of one PUCCH resource. The following uses multiple PUCCH resources as an example, which may also be applied to different signal sequences of one PUCCH resource.

For different UEs, for the transmission of HARQ-ACK information for the same PDSCH, the shared PUCCH resources may be used to transmit HARQ-ACK information, that is, the transmission of HARQ-ACK information for the same PDSCH is transmitted using the same PUCCH resources. For example, UE-1 receives PDSCH-1, and UE-1 transmits HARQ-ACK information for PDSCH-1 on PUCCH-1; and UE-2 receives PDSCH-1, UE-2 transmits HARQ-ACK information for PDSCH-1 on PUCCH-1.

According an embodiment of the disclosure, there are the following methods for the PUCCH resource indication.

If the UE decodes the PDSCH correctly, the UE does not feedback HARQ-ACK information, and if the UE receives the PDCCH but does not decode the PDSCH correctly, when the UE feedbacks NACK on the PUCCH resource, feedback for each PDSCH requires one PUCCH resource. At this time, if the UE receives a plurality of PDSCHs and the HARQ-ACK information for the plurality of PDSCHs is transmitted on one PUCCH resource, and the HARQ-ACK information for the same plurality of PDSCHs received by other UEs is transmitted on the same PUCCH resource, if the HARQ-ACK information for the plurality of PDSCHs of each UE is transmitted using the existing HARQ-ACK information transmission modes, the base station cannot distinguish the HARQ-ACK information for each of the PDSCHs. The HARQ-ACK information transmission method of the disclosure may at least address the above issues.

If the UE decodes the PDSCH correctly, the UE feedbacks an ACK on the PUCCH-1 resource, and if the UE receives the PDCCH but does not decode the PDSCH correctly, the UE feedbacks a NACK on the PUCCH-2 resource. The feedback for each PDSCH needs to involve a pair of PUCCH resources of 2 PUCCH resources.

### Example 1-1

Resources for transmitting HARQ-ACK information for each PDSCH is indicated by the PUCCH resource indicator (PRI) information in the DCI that schedules the PDSCH. The UE receives the PRI in the DCI of each scheduled PDSCH to determine a PUCCH resource or PUCCH resource pair for transmitting HARQ-ACK information for the PDSCH.

The advantage of adopting this method is that no additional signaling is required in the DCI.

### Example 1-2

The PRI information in the DCI for scheduling the PDSCH indicates PUCCH resources for transmitting the HARQ-ACK information for the group of PDSCHs in a group of PUCCH resources or a group of PUCCH resource pairs. The downlink assignment information (DAI) field is added to the DCI for scheduling the PDSCHs to indicate a number of PDSCHs that have been scheduled so far. The UE determines a number of a group of PUCCH resources for transmitting the HARQ-ACK information for this group of PDSCHs according to PRI and DAI in the received DCI that schedules the last PDSCH, wherein the number of the group of PUCCH resources for transmitting the HARQ-ACK information for this group of PDSCHs is indicated by the DAI in the DCI that schedules the last PDSCH. For example, when the DAI is equal to 3, a number of a group of PUCCH resources for transmitting the HARQ-ACK information for this group of PDSCHs is 3, wherein HARQ-ACK information for a first PDSCH in a group of PDSCHs (that is, the PDSCH with DAI equal to 1) is transmitted on a first PUCCH resource, HARQ-ACK information for a second PDSCH in the group of PDSCHs is transmitted on a second PUCCH resource, and HARQ-ACK information for a third PDSCH in the group of PDSCHs is transmitted on a third PUCCH resource, referring to FIG. 8. Here, the first, second, and third PDSCHs in the group of PDSCHs may be continuous or discontinuous in slot.

The advantage of adopting this method at least includes: when the PDSCHs in the middle are lost, the UE can still feedback the HARQ-ACK information for the lost PDSCHs, and the base station can retransmit the PDSCH.

The advantage of adopting this method also include: different UEs can use shared PUCCH resources to transmit HARQ-ACK information, and when the number of UEs receiving groupcast/multicast PDSCHs is relatively large, PUCCH resources for transmitting the HARQ-ACK information can be saved.

### Embodiment 2

When a UE receives a plurality of PDSCHs, the UE selects a PUCCH resource in a group of PUCCH resources according to HARQ-ACK information for the plurality of PDSCHs (or it also selects a signal sequence from a plurality of signal sequences in a PUCCH resource; the methods described below take selection of a PUCCH resource from a group of PUCCH resources as an example; these methods may also be applied to the situation where a signal sequence is selected from a plurality of signal sequences in a PUCCH resource) to transmit the HARQ-ACK information for the plurality of PDSCHs. Alternatively, a PUCCH resource pair in a group of PUCCH resource pairs (in which a PUCCH resource pair includes 2 PUCCH resources) is selected according to the HARQ-ACK information for the plurality of PDSCHs (or it is possible to select a signal sequence pair (which includes 2 signal sequences) from a plurality of signal sequence pairs in a PUCCH resource; the methods described below take selection of a PUCCH resource from a group of PUCCH resources as an example; these methods may also be applied to the situation where one signal sequence is selected from a plurality of signal sequences in a PUCCH resource) to transmit the HARQ-ACK information for the plurality of PDSCHs.

For different UEs receiving a groupcast/multicast PDSCH, shared PUCCH resources may be used to transmit HARQ-ACK information.

Using this method can at least avoid a UE from simultaneously transmitting HARQ-ACK information on a plurality of PUCCH resources that overlap in time, causing a large peak-to-average ratio, which affects the efficiency of the power amplifier.

### Example 2-1

According to an embodiment of the disclosure, a UE bundles HARQ-ACK information for a plurality of pieces of downlink data and transmits the bundled HARQ-ACK information on the determined second resource or resource pair.

For example, when the UE receives a plurality of PDSCHs, the UE bundles the HARQ-ACK information for the plurality of PDSCHs and then transmits the same on one PUCCH resource. If the HARQ-ACK information is NACK after being bundled, it is transmitted on the PUCCH resource. If the HARQ-ACK information is ACK after being bundled, it is not transmitted. For example, the HARQ-ACK information for 4 PDSCHs in 4 slots is transmitted on the PUCCH of one slot. If the HARQ-ACKs for 4 PDSCHs in 4 slots are all ACKs, the bundled HARQ-ACK information is ACK, under such a situation the HARQ-ACK information is not transmitted. If at least one of HARQ-ACKs for 4 PDSCHs in 4 slots is NACK, the bundled HARQ-ACK information is NACK, under such a situation the HARQ-ACK information is transmitted on PUCCH-1 resource. The above description is for one UE. For different UEs, shared PUCCH resources may be used to transmit the HARQ-ACK information. For example, different UEs, when the bundled HARQ-ACK information is the same, use the same PUCCH resources to transmit the HARQ-ACK feedback information. For example, for UE-1, if the bundled HARQ-ACK information is NACK, it is transmitted on the PUCCH-1 resource, for UE-2, if the bundled HARQ-ACK information is NACK, it is also transmitted on the PUCCH-1 resource.

Alternatively, when the UE receives a plurality of PDSCHs, the UE bundles the HARQ-ACK information for the plurality of PDSCHs and then transmits the same on one PUCCH resource. If the HARQ-ACK information is NACK after being bundled, it is transmitted on PUCCH-1 resource. If the HARQ-ACK information is ACK after being bundled, it is transmitted on PUCCH-2 resource. For example, the HARQ-ACK information for 4 PDSCHs in 4 slots is transmitted on the PUCCH of one slot. If the HARQ-ACKs for 4 PDSCHs in 4 slots are all ACKs, the bundled HARQ-ACK information is ACK, the HARQ-ACK information is transmitted on the PUCCH-2 resource. If at least one of HARQ-ACKs for 4 PDSCHs in 4 slots is NACK, the bundled HARQ-ACK information is NACK, under such a situation the HARQ-ACK information is transmitted on PUCCH-1 resource. The above description is for one UE. For different UEs, shared PUCCH resources may be used to transmit the HARQ-ACK information. For example, different UEs, when the bundled HARQ-ACK information is the same, use the same PUCCH resources to transmit the HARQ-ACK feedback information. For example, for UE-1, if the bundled HARQ-ACK information is ACK, it is transmitted on the PUCCH-2 resource; for UE-2, if the bundled HARQ-ACK information is ACK, it is also transmitted on the PUCCH-2 resource; for UE-1, if the bundled HARQ-ACK information is NACK, it is transmitted on the PUCCH-1 resource; for UE-2, if the bundled HARQ-ACK information is NACK, it is also transmitted on the PUCCH-1 resource.

The advantage of adopting this method at least includes: saving PUCCH resources.

### Example 2-2

According to an embodiment of the disclosure, a second resource or resource pair for transmitting HARQ-ACK information is determined based on a predetermined rule.

For example, when a UE receives a plurality of PDSCHs, the HARQ-ACK information for each PDSCH corresponds to a PUCCH resource. If there is only one PDSCH for which the HARQ-ACK information is NACK among the plurality of PDSCHs, the UE transmits the HARQ-ACK information for this PDSCH on a PUCCH resource corresponding to HARQ-ACK information for the PDSCH. If there are more than one PDSCH for which the HARQ-ACK information is NACK among the plurality of PDSCHs, according to a determined rule, the UE transmits the HARQ-ACK information for a PDSCH, for which the HARQ-ACK information is NACK, determined from the plurality of PDSCHs for which HARQ-ACK information is NACK, on a resource corresponding to such PDSCH. The determined rule may include determining a chronologically first one (or chronologically last one), for which HARQ-ACK information is NACK, in the plurality of PDSCHs received by the UE, as the PDSCH for which the HARQ-ACK information is to be transmitted by the UE. The HARQ-ACK information for a PDSCH, for which HARQ-ACK information is NACK, of other PDSCHs is not transmitted. For example, the UE receives PDSCH-1 in slot n, and the UE receives PDSCH-2 in slot n+2. According to the timing relationship, the UE transmits the HARQ-ACK information for PDSCH-1 and PDSCH-2 in slot n+4. If the HARQ-ACK information for PDSCH-1 is NACK and the HARQ-ACK information for PDSCH-2 is ACK, the UE transmits the HARQ-ACK information for PDSCH-1 on PUCCH-1; if the HARQ-ACK information for PDSCH-1 is ACK, and the HARQ-ACK information for PDSCH-2 is NACK, the UE transmits the HARQ-ACK information for PDSCH-2 on PUCCH-2; and if the HARQ-ACK information for PDSCH-1 is NACK, the HARQ-ACK information for PDSCH-2 is NACK, PDSCH-1 is the chronologically first PDSCH for which HARQ-ACK information is NACK in 2 PDSCHs received by the UE, the UE transmits the HARQ-ACK information for the PDSCH-1 on the PUCCH-1.

The advantage of adopting this method at least include: PUCCH resources can be saved, and in addition, a UE may be avoided from simultaneously transmitting HARQ-ACK information on a plurality of PUCCH resources that overlap in time, causing a large peak-to-average ratio.

### Example 2-3

According to an embodiment of the disclosure, a second resource or resource pair for transmitting the HARQ-ACK information is selected from a set of resources for transmitting HARQ-ACK information.

For example, when the UE receives at least one PDSCH, the UE determines a PUCCH resource from a set of PUCCH resource according to HARQ-ACK information for the received at least one PDSCH, and transmits the HARQ-ACK information for the at least one PDSCH on this PUCCH resource.

The specific implementation method may be as follows.

First, a set of PUCCH resources (or a set of signal sequences) is determined.

This set of resources may be determined in the following two ways. One way is determining the set of PUCCH resources semi-statically, that is, a method of determining the set of PUCCH resource according to the number of PDSCHs for which the HARQ-ACK information may be transmitted in uplink slots. For example, the PDSCH for which HARQ-ACK is transmitted in slot n may be in slot n−1, n−2, n−3 and n−4, and the set of PUCCH resources is determined according to the HARQ-ACK information for 4 PDSCHs that may be transmitted in slot n. The other way is dynamically determining the set of PUCCH resources, that is, a method of determining the set of PUCCH resources according to that the UE acknowledges receipt of the number of PDSCHs for which HARQ-ACK information is transmitted in uplink slot. For example, the UE receives the PDSCHs in slots n−2 and n−3, the set of PUCCH resources is determined according to the possible transmission of HARQ-ACK information for the received 2 PDSCHs in slot n.

Then, a PUCCH resource is determined from the determined set of PUCCH resources according to the HARQ-ACK information value for the PDSCH received by the UE.

The HARQ-ACK information for the PDSCH is transmitted on the determined PUCCH resource.

Below a description is made by way of illustrative examples.

### Embodiment 3

Downlink control information (DCI) for scheduling PDSCHs includes downlink assignment indication (DAI), and the UE knows a number L of PDSCHs for which the HARQ-ACK is fedback in the same uplink slot according to the DAI in the received DCI, and then the UE determines PUCCH resources for feedback according to the HARQ-ACK information for the PDSCH.

For example, when L is equal to 1, one method is that if the HARQ-ACK information for the PDSCH is NACK, the UE feedbacks the HARQ-ACK information for the PDSCH on the PUCCH resource. If the HARQ-ACK information for the PDSCH is ACK, the UE does not feedback the HARQ-ACK information for this PDSCH.

For example, when L is equal to 2, one method includes determining the transmission of the HARQ-ACK information for the PDSCH according to the method in Table 1.

TABLE 1
Correspondence between HARQ-ACK information for PDSCH
and PUCCH resource for feeding back HARQ-ACK

| HARQ-ACK | HARQ-ACK | PUCCH resource |
|---|---|---|
| information for | information for | for feeding back |
| first PDSCH | second PDSCH | HARQ-ACK |
| NACK | ACK | PUCCH-1 |
| NACK | NACK | PUCCH-2 |
| ACK | NACK | Not transmitted |
| ACK | ACK | Not transmitted |

For example, when L is equal to 3, one method includes determining the transmission of the HARQ-ACK information for the PDSCH according to the method in Table 2.

TABLE 2
Correspondence between HARQ-ACK information for
PDSCH and PUCCH resource for feeding back HARQ-ACK

| HARQ-ACK | HARQ-ACK | HARQ-ACK | PUCCH resource |
|---|---|---|---|
| information for | information for | information for | for feeding back |
| first PDSCH | second PDSCH | third PDSCH | HARQ-ACK |
| NACK | ACK | ACK/NACK | PUCCH-1 |
| NACK | NACK | ACK | PUCCH-2 |
| NACK | NACK | NACK | PUCCH-3 |
| ACK | NACK | ACK/NACK | Not transmitted |
| ACK | ACK | ACK/NACK | Not transmitted |

For example, when L is equal to 4, one method includes determining the transmission of the HARQ-ACK information for the PDSCH according to the method in Table 3.

TABLE 3
Correspondence between HARQ-ACK information for
PDSCH and PUCCH resource for feeding back HARQ-ACK

| HARQ- | HARQ- | HARQ- | HARQ- | PUCCH |
|---|---|---|---|---|
| ACK infor- | ACK infor- | ACK infor- | ACK infor- | resource |
| mation for | mation for | mation for | mation for | for feeding |
| first | second | third | fourth | back |
| PDSCH | PDSCH | PDSCH | PDSCH | HARQ-ACK |
| NACK | ACK | ACK/NACK | ACK/NACK | PUCCH-1 |
| NACK | NACK | ACK | ACK/NACK | PUCCH-2 |
| NACK | NACK | NACK | ACK | PUCCH-3 |
| NACK | NACK | NACK | NACK | PUCCH-4 |
| ACK | NACK | ACK/NACK | ACK/NACK | Not |
| | | | | transmitted |
| ACK | ACK | ACK/NACK | ACK/NACK | Not |
| | | | | transmitted |

When L is greater than 4, a similar method can be used to transmit the HARQ-ACK information.

The advantage of adopting this method at least includes: saving PUCCH resources.

### Embodiment 4

DCI for scheduling PDSCHs includes DAI, and the UE knows a number L of PDSCHs for which the HARQ-ACK is fedback in the same uplink slot according to the DAI in the received DCI, and then the UE determines PUCCH resources for feedback according to the HARQ-ACK information for the PDSCH.

For example, when L is equal to 1, one method is that if the HARQ-ACK information for the PDSCH is NACK, the UE feedbacks the HARQ-ACK information for the PDSCH on the PUCCH resource. If the HARQ-ACK information for the PDSCH is ACK, the UE does not feedback the HARQ-ACK information for the PDSCH. Another method is that if the HARQ-ACK information for the PDSCH is NACK, the UE feedbacks the HARQ-ACK information for the PDSCH on the PUCCH-1 resource, and if the HARQ-ACK information for the PDSCH is ACK, the UE feedbacks the HARQ-ACK information for the PDSCH on the PUCCH-2 resource.

For example, when L is equal to 2, one method includes determining the transmission of the HARQ-ACK information for the PDSCH according to the method in Table 4. When the HARQ-ACK information for all PDSCHs is ACK, the UE does not feedback the HARQ-ACK information. Another method includes determining the transmission of the HARQ-ACK information for the PDSCH according to the method in Table 5. When the HARQ-ACK information for all PDSCHs is ACK, the UE feedbacks the HARQ-ACK information.

TABLE 4
Correspondence between HARQ-ACK information for
PDSCH and PUCCH resource for feeding back HARQ-ACK

| HARQ-ACK | HARQ-ACK | PUCCH resource |
|---|---|---|
| information for | information for | for feeding back |
| first PDSCH | second PDSCH | HARQ-ACK |
| NACK | ACK | PUCCH-1 |
| NACK | NACK | PUCCH-2 |
| ACK | NACK | PUCCH-3 |
| ACK | ACK | Not transmitted |

TABLE 5
Correspondence between HARQ-ACK information for
PDSCH and PUCCH resource for feeding back HARQ-ACK

| HARQ-ACK | HARQ-ACK | PUCCH resource |
|---|---|---|
| information for | information for | for feeding back |
| first PDSCH | second PDSCH | HARQ-ACK |
| NACK | ACK | PUCCH-1 |
| NACK | NACK | PUCCH-2 |
| ACK | NACK | PUCCH-3 |
| ACK | ACK | PUCCH-4 |

For example, when L is equal to 3, one method includes determining the transmission of the HARQ-ACK information for the PDSCH according to the method in Table 6. When L is equal to 3 and the HARQ-ACK information for the third PDSCH is ACK, the correspondence of the HARQ-ACK information for the first PDSCH, the HARQ-ACK information for the second PDSCH and the PUCCH resource for feeding back HARQ-ACK is the same as when L is equal to 2. For example, the correspondence of the HARQ-ACK information for the first PDSCH, the HARQ-ACK information for the second PDSCH and the PUCCH resource for feeding back HARQ-ACK in first 3 rows of Table 6 is same as the correspondence of the HARQ-ACK information for the first PDSCH, the HARQ-ACK information for the second PDSCH and the PUCCH resource for feeding back HARQ-ACK in first 3 rows of Table 4. The advantage of using this method is that if the base station transmits a third PDSCH but the UE does not receive the third PDSCH, inconsistent understanding of the transmission of HARQ-ACK information between the base station and the UE would be avoided. When the HARQ-ACK information for all PDSCHs is ACK, the UE does not feedback the HARQ-ACK information. Another method includes determining the transmission of the HARQ-ACK information for the PDSCH according to the method in Table 7. When the HARQ-ACK information for all PDSCHs is ACK, the UE feedbacks the HARQ-ACK information.

TABLE 6
Correspondence between HARQ-ACK information for
PDSCH and PUCCH resource for feeding back HARQ-ACK

| HARQ-ACK | HARQ-ACK | HARQ-ACK | PUCCH resource |
|---|---|---|---|
| information for | information for | information for | for feeding back |
| first PDSCH | second PDSCH | third PDSCH | HARQ-ACK |
| NACK | ACK | ACK | PUCCH-1 |
| NACK | NACK | ACK | PUCCH-2 |
| ACK | NACK | ACK | PUCCH-3 |
| NACK | ACK | NACK | PUCCH-4 |
| NACK | NACK | NACK | PUCCH-5 |
| ACK | NACK | NACK | PUCCH-6 |
| NACK | NACK | NACK | PUCCH-7 |
| ACK | ACK | ACK | Not transmitted |

TABLE 7
Correspondence between HARQ-ACK information for
PDSCH and PUCCH resource for feeding back HARQ-ACK

| HARQ-ACK | HARQ-ACK | HARQ-ACK | PUCCH resource |
|---|---|---|---|
| information for | information for | information for | for feeding back |
| first PDSCH | second PDSCH | third PDSCH | HARQ-ACK |
| NACK | ACK | ACK | PUCCH-1 |
| NACK | NACK | ACK | PUCCH-2 |
| ACK | NACK | ACK | PUCCH-3 |
| NACK | ACK | NACK | PUCCH-4 |
| NACK | NACK | NACK | PUCCH-5 |
| ACK | NACK | NACK | PUCCH-6 |
| NACK | NACK | NACK | PUCCH-7 |
| ACK | ACK | ACK | PUCCH-8 |

For example, when L is equal to 4, one method includes determining the transmission of the HARQ-ACK information for the PDSCH according to the method in Table 8. When L is equal to 4 and the HARQ-ACK information for the fourth PDSCH is ACK, the correspondence of the HARQ-ACK information for the first PDSCH, the HARQ-ACK information for the second PDSCH, the HARQ-ACK information for the third PDSCH and the PUCCH resource for feeding back HARQ-ACK is the same as when L is equal to 3. For example, the correspondence of the HARQ-ACK information for the first PDSCH, the HARQ-ACK information for the second PDSCH, the HARQ-ACK information for the third PDSCH and the PUCCH resource for feeding back HARQ-ACK in first 7 rows of Table 8 is same as the correspondence of the HARQ-ACK information for the first PDSCH, the HARQ-ACK information for the second PDSCH, the HARQ-ACK information for the third PDSCH and the PUCCH resource for feeding back HARQ-ACK in first 7 rows of Table 6. The advantage of using this method is that if the base station transmits a fourth PDSCH but the UE does not receive the fourth PDSCH, inconsistent understanding of the transmission of HARQ-ACK information between the base station and the UE would be avoided. When the HARQ-ACK information for all PDSCHs is ACK, the UE does not feedback the HARQ-ACK information. Another method includes determining the transmission of the HARQ-ACK information for the PDSCH according to the method in Table 9. When the HARQ-ACK information for all PDSCHs is ACK, the UE feedbacks the HARQ-ACK information.

TABLE 8
Correspondence between HARQ-ACK information for
PDSCH and PUCCH resource for feeding back HARQ-ACK

| HARQ- | HARQ- | HARQ- | HARQ- | PUCCH |
|---|---|---|---|---|
| ACK infor- | ACK infor- | ACK infor- | ACK infor- | resource |
| mation for | mation for | mation for | mation for | for feeding |
| first | second | third | fourth | back |
| PDSCH | PDSCH | PDSCH | PDSCH | HARQ-ACK |
| NACK | ACK | ACK | ACK | PUCCH-1 |
| NACK | NACK | ACK | ACK | PUCCH-2 |
| ACK | NACK | ACK | ACK | PUCCH-3 |
| ACK | NACK | NACK | ACK | PUCCH-4 |
| ACK | ACK | NACK | ACK | PUCCH-5 |
| NACK | ACK | NACK | ACK | PUCCH-6 |
| NACK | NACK | NACK | ACK | PUCCH-7 |
| NACK | ACK | ACK | NACK | PUCCH-8 |
| NACK | NACK | ACK | NACK | PUCCH-9 |
| ACK | NACK | ACK | NACK | PUCCH-10 |
| ACK | NACK | NACK | NACK | PUCCH-11 |
| ACK | ACK | NACK | NACK | PUCCH-12 |
| NACK | ACK | NACK | NACK | PUCCH-13 |
| NACK | NACK | NACK | NACK | PUCCH-14 |
| ACK | ACK | ACK | NACK | PUCCH-15 |
| ACK | ACK | ACK | ACK | Not |
| | | | | transmitted |

TABLE 9
Correspondence between HARQ-ACK information for
PDSCH and PUCCH resource for feeding back HARQ-ACK

| HARQ- | HARQ- | HARQ- | HARQ- | PUCCH |
|---|---|---|---|---|
| ACK infor- | ACK infor- | ACK infor- | ACK infor- | resource |
| mation for | mation for | mation for | mation for | for feeding |
| first | second | third | fourth | back |
| PDSCH | PDSCH | PDSCH | PDSCH | HARQ-ACK |
| NACK | ACK | ACK | ACK | PUCCH-1 |
| NACK | NACK | ACK | ACK | PUCCH-2 |
| ACK | NACK | ACK | ACK | PUCCH-3 |
| ACK | NACK | NACK | ACK | PUCCH-4 |
| ACK | ACK | NACK | ACK | PUCCH-5 |
| NACK | ACK | NACK | ACK | PUCCH-6 |
| NACK | NACK | NACK | ACK | PUCCH-7 |
| NACK | ACK | ACK | NACK | PUCCH-8 |
| NACK | NACK | ACK | NACK | PUCCH-9 |
| ACK | NACK | ACK | NACK | PUCCH-10 |
| ACK | NACK | NACK | NACK | PUCCH-11 |
| ACK | ACK | NACK | NACK | PUCCH-12 |
| NACK | ACK | NACK | NACK | PUCCH-13 |
| NACK | NACK | NACK | NACK | PUCCH-14 |
| ACK | ACK | ACK | NACK | PUCCH-15 |
| ACK | ACK | ACK | ACK | PUCCH-16 |

When L is greater than 4, a similar method may be used to transmit the HARQ-ACK information.

Using the above method, for a plurality of UEs receiving a groupcast/multicast PDSCH, the HARQ-ACK information is transmitted through the same PUCCH resources shared by the plurality of UEs, thereby saving PUCCH resources for transmitting HARQ-ACK.

According to another embodiment of the disclosure, a method performed by a base station in a wireless communication system is provided. The method may include: transmitting control information to a user equipment; transmitting a plurality of pieces of downlink data to the user equipment, based on the control information; and receiving HARQ-ACK information from the user equipment on the resource for receiving the HARQ-ACK information, wherein the resource is determined for the plurality of pieces of downlink data, based on the control information, and includes: a first resource or resource for transmitting the HARQ-ACK information determined for each of the plurality of pieces of downlink data; or a second resource or resource pair for transmitting the HARQ-ACK information determined for the plurality of pieces of downlink data.

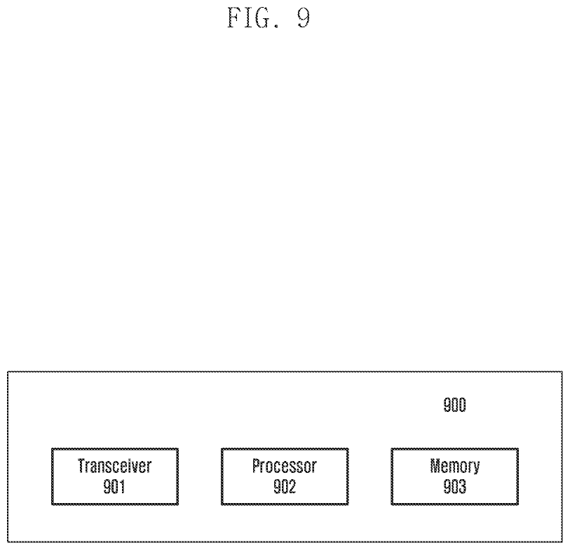

FIG. 9 illustrates a block diagram of a UE according to an embodiment of the disclosure.

Referring to FIG. 9, a UE 900 includes a transceiver 901, a processor 902, and a memory 903. Under the control of the processor 902 (which may be implemented as one or more processors), the UE 900 may be configured to perform related operations performed by the UE in the method described above. while the transceiver 901, the processor 902, and the memory 903 are illustrated as separate entities, they may be implemented as a single entity, such as a single chip. The transceiver 901, the processor 902, and the memory 903 may be connected to each other, for example, electrically connected or coupled. The transceiver 901 may transmit signals to and receive signals from other network entities, such as nodes (which may be, for example, base stations, relay nodes, or the like) and/or another UE. In some implementations, the transceiver 901 may be omitted. In such a case, the processor 902 may be configured to execute instructions (including computer programs) stored in the memory 903 to control the overall operation of the UE 900, thereby implementing the operations in the flow of the foregoing method.

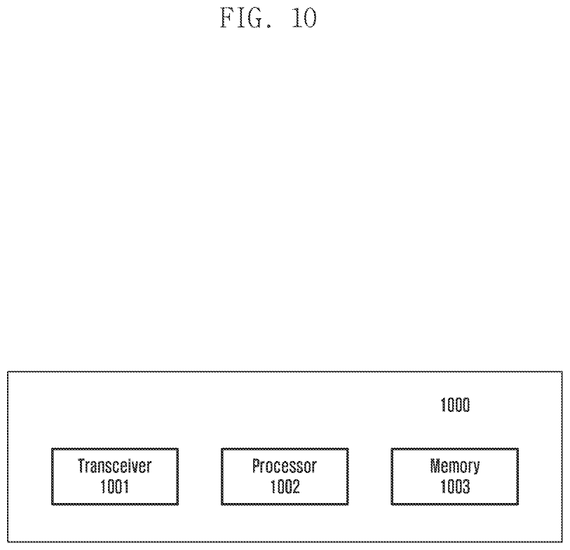

FIG. 10 illustrates a block diagram of a base station according to an embodiment of the disclosure.

Referring to FIG. 10, a base station 1000 includes a transceiver 1001, a processor 1002, and a memory 1003. Under the control of the processor 1002 (which may be implemented as one or more processors), the base station 1000 may be configured to perform related operations performed by the base station in the method described above. while the transceiver 1001, the processor 1002, and the memory 1003 are illustrated as separate entities, they may be implemented as a single entity, such as a single chip. The transceiver 1001, the processor 1002, and the memory 1003 may be connected to each other, for example, electrically connected or coupled. The transceiver 1001 may transmit signals to and receive signals from other network entities, such as another node (which may be, for example, a base station, a relay node, or the like) and/or a UE. In some implementations, the transceiver 1001 may be omitted. In such a case, the processor 1002 may be configured to execute instructions (including computer programs) stored in the memory 1003 to control the overall operation of the base station 1000, thereby implementing the operations in the flow of the foregoing method.

This application also proposes a communication method that can effectively start and/or end reception of PDSCH.

The various embodiments of the disclosure are further described below in connection with the accompanying drawings.

The text and drawings are provided as examples only to help readers understand the disclosure. They are not intended and should not be construed as limiting the scope of the disclosure in any way. While certain embodiments and examples have been provided, based on the content disclosed herein, it is obvious to those skilled in the art that the embodiments and examples illustrated can be modified without departing from the scope of the disclosure.

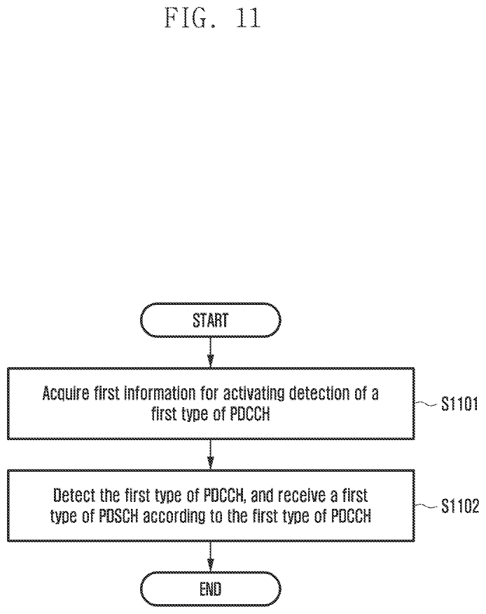

FIG. 11 is a schematic flowchart of a communication method according to an embodiment of the disclosure.

An embodiment of the disclosure provides a communication method. Referring to FIG. 11, the method includes:

Operation S1101: acquiring first information for activating detection of a first type of PDCCH; and

Operation S1102: detecting the first type of PDCCH, and receiving a first type of PDSCH according to the first type of PDCCH.

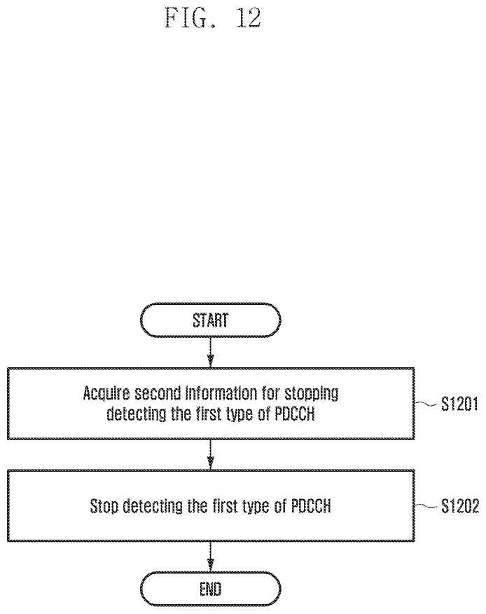

FIG. 12 is a schematic flowchart of a communication method according to an embodiment of the disclosure.

And/or, referring to FIG. 12, the method includes:

Operation S1201: acquiring second information for stopping detecting the first type of PDCCH; and

Operation S1202: stopping detecting the first type of PDCCH,

wherein, the first type of PDSCH may be a groupcast/multicast PDSCH or a broadcast PDSCH, or may be other types of PDSCH. The description below is made in the context of the first type of PDSCH, the method may also be applicable to operations of other types of PDSCH.

In the embodiment of the disclosure, the process shown in FIG. 11 and the process shown in FIG. 12 may be executed separately or sequentially, which is not limited in the embodiment of the disclosure.

In the embodiment of the disclosure, the method for starting to receive the PDSCH shown in FIG. 11 is implemented on the UE side. Specifically, after acquiring (which may be, for example, receiving) the first information in operation S1101, operation S1102 may include following operations:

Operation S11021: determining, based on the first information, configuration information for detecting the first type of PDCCH and configuration information for receiving the first type of PDSCH;

Operation S11022: starting the detection of the first type of PDCCH based on the determined configuration information for detecting the first type of PDCCH;

Operation S11023: receiving the first type of PDSCH based on the detected first type of PDCCH and the determined configuration information for the first type of PDSCH.

It can be understood that after the detection of the first type of PDCCH is activated, the first type of PDSCH may be further received. For ease of description, the processes may be straightly referred to as detecting the first type of PDCCH and receiving the first type of PDSCH in the description below.

The first information may be at least one of physical layer signaling, media access layer signaling, higher layer signaling (higher layer signaling configuration information), or reference signal indication information.

An implementation in which the first information is physical layer signaling is described below.

For example, the UE activates the detection of the first type of PDCCH and reception of the first type of PDSCH by receiving the indication of the physical layer signaling.

An Optional Solution:

The physical layer signaling is DCI format x (DCI format x may be an existing DCI format, for example, DCI format 2-6, or a new DCI format). For example, the UE implements the transmission of the first information by receiving the DCI of the DCI format x. Based on the DCI format x, the first type of PDCCH may be detected through a common search space (CSS). The DCI format x may be transmitted in the CSS of a primary cell (Pcell) for the UE, or in the CSS of a configured secondary cell.

In the embodiment of the disclosure, the DCI format x may be used to activate at least one UE to start detecting the first type of PDCCH and receiving the first type of PDSCH.

In the embodiment of the disclosure, information transmitted in the DCI format x may include:

Information block 1, Information block 2, . . . , Information block N,

wherein, each UE may determine the location of its corresponding information block through the configuration of higher layer signaling.

In the embodiment of the disclosure, the first information includes at least one of the following:

activation indication (which may be indicated by preset bits);

configuration information for detecting the first type of PDCCH; and

configuration information for receiving the first type of PDSCH.

For example, information in the information block of DCI format x may include:
activation indication 0, 1 bit;
configuration information for detecting the first type of PDCCH and configuration information of receiving the first type of PDSCH.

In the embodiment of this application, a number of bits of configuration information for detecting the first type of PDCCH is determined according to a number of configurations for detecting the first type of PDCCH. For example, a number of bits of configuration information for detecting the first type of PDCCH and receiving the first type of PDSCH is determined based on a number of configurations for detecting the first type of PDCCH and receiving the first type of PDSCH.

As an example, if there is only a set of configurations for detecting the first type of PDCCH and receiving the first type of PDSCH, the number of bits of the configuration information for detecting the first type of PDCCH and receiving the first type of PDSCH may be 0 bits.

If there are multiple sets of configurations for detecting the first type of PDCCH and receiving the first type of PDSCH, the number of bits of configuration information for detecting the first type of PDCCH and receiving the first type of PDSCH is determined based on a number M of configurations for detecting the first type of PDCCH and receiving the first type of PDSCH, the number of bits being x=┌log₂M┐ bits, wherein ┌ ┐ is rounding up operation.

In an embodiment of the application, when the activation indication is a first preset value, the first type of PDCCH may be detected;

when the activation indication is a second preset value, corresponding information block in the first information is determined, and whether to detect the first type of PDCCH is determined according to the activation indication in the information block.

Those skilled in the art could set the first preset value and the second preset value according to the actual scenarios. The embodiment of the disclosure does not pose any limitation in this regard. In an example, the first preset value may be 0 bit, and the second preset value may be 1 bit.

As an example, if the activation indication is 0 bit, once the UE receives the DCI of the DCI format x, it starts to detect the first type of PDCCH and receive the first type of PDSCH. If the activation indication is 1 bit, after the UE receives the DCI of DCI format x, it finds the information block of the UE in the DCI. If the activation indication in the information block is ‘0’, the UE does not start to detect the first type of PDCCH and receive the first type of PDSCH, and if the activation indication in the information block is ‘1’, the UE starts detecting the first type of PDCCH and receiving the first type of PDSCH according to the configuration information for detecting the first type of PDCCH and receiving the first type of PDSCH.

In the embodiment of the disclosure, when there are at least two sets of configurations for detecting the first type of PDCCH, a configuration for detecting the first type of PDCCH to be used is determined according to the configuration information for detecting the first type of PDCCH, and the first type of PDCCH is detected according to the determined configuration for detecting the first type of PDCCH.

If there is only a set of configurations for detecting the first type of PDCCH and receiving the first type of PDSCH, after the UE receives the activation information for detecting the first type of PDCCH and receiving the first type of PDSCH, the UE starts to detect the first type of PDCCH and receive the first type of PDSCH according to the configurations for detecting the first type of PDCCH and receiving the first type of PDSCH. If there are more than one set of configurations for detecting the first type of PDCCH and receiving the first type of PDSCH, the UE would determine a configuration for detecting the first type of PDCCH and receiving the first type of PDSCH according to the configuration information for detecting the first type of PDCCH and receiving the first type of PDSCH. The determination method may be determined according to correspondence between the configuration information for detecting the first type of PDCCH and receiving the first type of PDSCH and the configurations for detecting the first type of PDCCH and receiving the first type of PDSCH. The configuration information for detecting the first type of PDCCH and receiving the first type of PDSCH may be k bits, k being a positive integer. For example, where k is 2 bits as an example, correspondence between the configuration information for detecting the first type of PDCCH and receiving the first type of PDSCH and the configurations for detecting the first type of PDCCH and receiving the first type of PDSCH is shown in Table 10. After the UE determines the configuration for detecting the first type of PDCCH and receiving the first type of PDSCH, the UE starts to detect the first type of PDCCH and receive the first type of PDSCH according to the determined configuration for detecting the first type of PDCCH and receiving the first type of PDSCH.

TABLE 10

| configuration information | configuration for |
|---|---|
| for detecting first type of | detecting first type of |
| PDCCH and receiving | PDCCH and receiving |
| first type of PDSCH | first type of PDSCH |
| 00 | Configuration I |
| 01 | Configuration II |
| 10 | Configuration III |
| 11 | Configuration IV |

Another Optional Solution:

The physical layer signaling is DCI format y (DCI format y may be an existing DCI format, for example, DCI format 1-1, 0-1, or a new DCI format). DCI format y can be used to activate a UE to detect the first type of PDCCH. Based on the DCI format y, the first type of PDCCH may be detected through a UE-specific Search Space (USS).

In the embodiment of the disclosure, the DCI format y may be distinguished according to the cyclic redundancy check (CRC), scrambled by the radio network temporary identity (RNTI), of the DCI format y. For example, the DCI with the CRC scrambled by Multicast Broadcast Service (MBS)-start-RNTI is DCI containing the first information, which is used to activate the detection of the first type of PDCCH and reception of the first type of PDSCH.

Alternatively, a DCI with a different size from the existing DCI is used to distinguish the DCI format y, which is used to activate the detection of the first type of PDCCH and reception of the first type of PDSCH.

Alternatively, a DCI of an existing DCI size is used to distinguish the DCI format y by setting a field in the DCI to a preset value, for example, xxxx, which is used to activate the detection of the first type of PDCCH and reception of the first type of PDSCH.

In the embodiment of the disclosure, the first information includes at least one of the following:

activation indication (which may be indicated by preset bits);

configuration information for detecting the first type of PDCCH; and

configuration information for receiving the first type of PDSCH.

For example, information for activating the detection of the first type of PDCCH and reception of the first type of PDSCH in the DCI format y may include:
activation indication 0, 1 bit;
configuration information for detecting the first type of PDCCH and configuration information for receiving the first type of PDSCH.

In the embodiment of this application, a number of bits of configuration information for detecting the first type of PDCCH is determined according to a number of configurations for detecting the first type of PDCCH. For example, a number of bits of configuration information for detecting the first type of PDCCH and receiving the first type of PDSCH is determined based on a number of configurations for detecting the first type of PDCCH and receiving the first type of PDSCH.

As an example, if there is only a set of configurations for detecting the first type of PDCCH and receiving the first type of PDSCH, the number of bits of the configuration information for detecting the first type of PDCCH and receiving the first type of PDSCH may be 0 bit.

If there are multiple sets of configurations for detecting the first type of PDCCH and receiving the first type of PDSCH, the number of bits of configuration information for detecting the first type of PDCCH and receiving the first type of PDSCH is determined based on the number M of configurations for detecting the first type of PDCCH and receiving the first type of PDSCH, the number of bits being x=[log 2M] bits, wherein [ ] is rounding up operation.

In an embodiment of the application, when the activation indication is a first preset value, the first type of PDCCH may be detected;

when the activation indication is a second preset value, corresponding information block in the first information is determined, and whether to detect the first type of PDCCH is determined according to the activation indication in the information block.

Those skilled in the art could set the first preset value and the second preset value according to the actual scenarios. The embodiment of the disclosure does not pose any limitation in this regard. In an example, the first preset value may be 0 bit, and the second preset value may be 1 bit.

As an example, if the activation indication is 0 bit, once the UE receives the DCI of the DCI format y, it starts to detect the first type of PDCCH and receive the first type of PDSCH. If the activation indication is 1 bit, after the UE receives the DCI of DCI format y, it finds the information block of the UE in the DCI. If the activation indication in the information block is ‘0’, the UE does not start to detect the first type of PDCCH and receive the first type of PDSCH, and if the activation indication in the information block is ‘1’, the UE starts detecting the first type of PDCCH and receiving the first type of PDSCH according to the configuration information for detecting the first type of PDCCH and receiving the first type of PDSCH.

In the embodiment of the disclosure, when there are at least two sets of configurations for detecting the first type of PDCCH, a configuration for detecting the first type of PDCCH to be used is determined according to the configuration information for detecting the first type of PDCCH, and the first type of PDCCH is detected according to the determined configuration for detecting the first type of PDCCH.

If there is only a set of configurations for detecting the first type of PDCCH and receiving the first type of PDSCH, after the UE receives the activation information for detecting the first type of PDCCH and receiving the first type of PDSCH, the UE starts to detect the first type of PDCCH and receive the first type of PDSCH according to the configurations for detecting the first type of PDCCH and receiving the first type of PDSCH. If there are more than one set of configurations for detecting the first type of PDCCH and receiving the first type of PDSCH, the UE would determine a configuration for detecting the first type of PDCCH and receiving the first type of PDSCH according to the configuration information for detecting the first type of PDCCH and receiving the first type of PDSCH. The determination method may be determined according to correspondence between the configuration information for detecting the first type of PDCCH and receiving the first type of PDSCH and the configurations for detecting the first type of PDCCH and receiving the first type of PDSCH. The configuration information for detecting the first type of PDCCH and receiving the first type of PDSCH may be k bits, k being a positive integer. For example, where k is 2 bits as an example, correspondence between the configuration information for detecting the first type of PDCCH and receiving the first type of PDSCH and the configurations for detecting the first type of PDCCH and receiving the first type of PDSCH is shown in Table 10. After the UE determines the configuration for detecting the first type of PDCCH and receiving the first type of PDSCH, the UE starts to detect the first type of PDCCH and receive the first type of PDSCH according to the determined configuration for detecting the first type of PDCCH and receiving the first type of PDSCH.

An implementation in which the first information is media access layer signaling is described below.

For example, the UE activates the detection of the first type of PDCCH and reception of the first type of PDSCH by receiving the indication of the media access layer signaling (the indication information of the media access layer).

In the embodiment of the disclosure, the first information includes at least one of the following:

activation indication (which may be indicated by preset bits);

configuration information for detecting the first type of PDCCH;

configuration information for receiving the first type of PDSCH.

For example, the first information of the media access layer signaling may include:
activation indication 0, 1 bit;
configuration information for detecting the first type of PDCCH and configuration information for receiving the first type of PDSCH.

In the embodiment of this application, a number of bits of configuration information for detecting the first type of PDCCH is determined according to a number of configurations for detecting the first type of PDCCH. For example, a number of bits of configuration information for detecting the first type of PDCCH and receiving the first type of PDSCH is determined based on a number of configurations for detecting the first type of PDCCH and receiving the first type of PDSCH.

As an example, if there is only a set of configurations for detecting the first type of PDCCH and receiving the first type of PDSCH, the number of bits of the configuration information for detecting the first type of PDCCH and receiving the first type of PDSCH may be 0 bit.

If there are multiple sets of configurations for detecting the first type of PDCCH and receiving the first type of PDSCH, the number of bits of configuration information for detecting the first type of PDCCH and receiving the first type of PDSCH is determined based on the number M of configurations for detecting the first type of PDCCH and receiving the first type of PDSCH, the number of bits being x=┌log₂M┐ bits, wherein ┌ ┐ is rounding up operation.

In an embodiment of the application, when the activation indication is a first preset value, the first type of PDCCH may be detected;

when the activation indication is a second preset value, corresponding information block in the first information is determined, and whether to detect the first type of PDCCH is determined according to the activation indication in the information block.

Those skilled in the art could set the first preset value and the second preset value according to the actual scenarios. The embodiment of the disclosure does not pose any limitation in this regard. In an example, the first preset value may be 0 bit, and the second preset value may be 1 bit.

As an example, if the activation indication is 0 bit, once the UE receives the indication information of the media access layer, it starts to detect the first type of PDCCH and receive the first type of PDSCH. If the activation indication is 1 bit, after the UE receives the indication information of the media access layer, it finds the information block of the UE in the indication information. If the activation indication in the information block is ‘0’, the UE does not start to detect the first type of PDCCH and receive the first type of PDSCH, and if the activation indication in the information block is ‘1’, the UE starts detecting the first type of PDCCH and receiving the first type of PDSCH according to the configuration information for detecting the first type of PDCCH and receiving the first type of PDSCH.

In the embodiment of the disclosure, when there are at least two sets of configurations for detecting the first type of PDCCH, a configuration for detecting the first type of PDCCH to be used is determined according to the configuration information for detecting the first type of PDCCH, and the first type of PDCCH is detected according to the determined configuration for detecting the first type of PDCCH.

If there is only a set of configurations for detecting the first type of PDCCH and receiving the first type of PDSCH, after the UE receives the activation information for detecting the first type of PDCCH and receiving the first type of PDSCH, the UE starts to detect the first type of PDCCH and receive the first type of PDSCH according to the configurations for detecting the first type of PDCCH and receiving the first type of PDSCH. If there are more than one set of configurations for detecting the first type of PDCCH and receiving the first type of PDSCH, the UE would determine a configuration for detecting the first type of PDCCH and receiving the first type of PDSCH according to the configuration information for detecting the first type of PDCCH and receiving the first type of PDSCH. The determination method may be determined according to correspondence between the configuration information for detecting the first type of PDCCH and receiving the first type of PDSCH and the configurations for detecting the first type of PDCCH and receiving the first type of PDSCH. The configuration information for detecting the first type of PDCCH and receiving the first type of PDSCH may be k bits, k being a positive integer. For example, where k is 2 bits as an example, correspondence between the configuration information for detecting the first type of PDCCH and receiving the first type of PDSCH and the configurations for detecting the first type of PDCCH and receiving the first type of PDSCH is shown in Table 10. After the UE determines the configuration for detecting the first type of PDCCH and receiving the first type of PDSCH, the UE starts to detect the first type of PDCCH and receive the first type of PDSCH according to the determined configuration for detecting the first type of PDCCH and receiving the first type of PDSCH.

An implementation in which the first information is higher layer signaling is described below.

For example, the UE activates the detection of the first type of PDCCH and reception of the first type of PDSCH by receiving the indication of the higher layer signaling.

In the embodiment of the disclosure, the first information includes at least one of the following:

activation indication (which may be indicated by preset bits);

configuration information for detecting the first type of PDCCH; and

configuration information for receiving the first type of PDSCH.

For example, the first information of the higher layer signaling may include:
activation indication 0, 1 bit;
configuration information for detecting the first type of PDCCH and configuration information for receiving the first type of PDSCH.

In this embodiment of the disclosure, when there are at least two sets of configurations for detecting the first type of PDCCH, the first type of PDCCH is detected according to the configuration for detecting the first type of PDCCH indicated by the higher layer signaling.

If there is only a set of configurations for detecting the first type of PDCCH and receiving the first type of PDSCH, the number of bits of the configuration information for detecting the first type of PDCCH and receiving the first type of PDSCH may be 0 bit.

If there are multiple sets of configurations for detecting the first type of PDCCH and receiving the first type of PDSCH, the higher layer signaling configuration activates the used configuration for detecting the first type of PDCCH and receiving the first type of PDSCH.

In an embodiment of the disclosure, when the activation indication is a first preset value, the first type of PDCCH may be detected;

when the activation indication is a second preset value, corresponding information block in the first information is determined, and whether to detect the first type of PDCCH is determined according to the activation indication in the information block.

Those skilled in the art can set the first preset value and the second preset value according to the actual situation. The embodiment of the disclosure does not pose any limitation in this regard. In an example, the first preset value may be 0 bit, and the second preset value may be 1 bit.

As an example, if the activation indication is 0 bit, once the UE receives the indication information of the high layer signaling, it starts to detect the first type of PDCCH and receive the first type of PDSCH. If the activation indication is 1 bit, after the UE receives the indication information of the high layer signaling, it finds the information block of the UE in the indication information. If the activation indication in the information block is ‘0’, the UE does not start to detect the first type of PDCCH and receive the first type of PDSCH, and if the activation indication in the information block is ‘1’, the UE starts detecting the first type of PDCCH and receiving the first type of PDSCH according to the configuration information for detecting the first type of PDCCH and receiving the first type of PDSCH.

In the embodiments of the disclosure, for the foregoing embodiments of the disclosure, each set of configurations for detecting the first type of PDCCH and receiving the first type of PDSCH may be configured by the higher layer signaling.

The configuration information for detecting the first type of PDCCH and the configuration information for receiving the first type of PDSCH includes at least one of the following:

a serving cell in which the first type of PDCCH is detected and the first type of PDSCH is received;

downlink band width part (BWP) in which the first type of PDCCH is detected and the first type of PDSCH is received;

a frequency domain position of a resource for detecting the first type of PDCCH and receiving the first type of PDSCH, in the downlink BWP;

configuration information for a control resource set (CORESET) for detecting the first type of PDCCH;

configuration information for a search space for detecting the first type of PDCCH; and

configuration information for receiving the first type of PDSCH.

By receiving the configuration information for detecting the first type of PDCCH and configuration information for receiving the first type of PDSCH, the UE may obtain the serving cell in which the UE detects the first type of PDCCH and receives the first type of PDSCH, the BWP in which the UE detects the first type of PDCCH and receives the first type of PDSCH, the configuration information for the control resource set for detecting the first type of PDCCH, the configuration information for search space for the first type of PDCCH and the like. In addition, the UE knows whether the serving cell in which the UE detects the first type of PDCCH and receives the first type of PDSCH is currently an activated serving cell. If the serving cell in which the UE detects the first type of PDCCH and receives the first type of PDSCH is currently an activated serving cell, the UE knows whether the downlink BWP, in which the first type of PDCCH is detected and the first type of PDSCH is received, is an activated BWP.

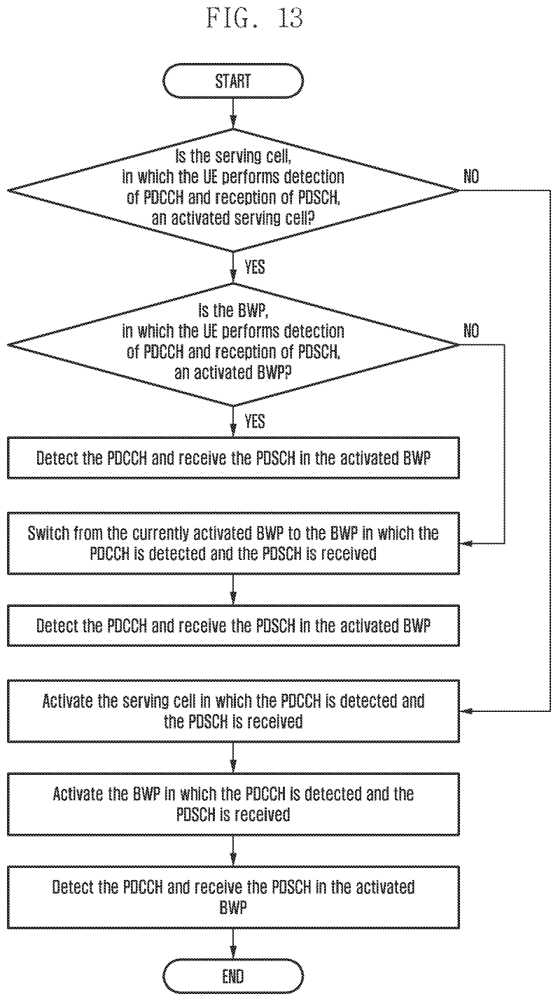

FIG. 13 is a schematic diagram of a flowchart of detecting a first type of PDCCH and receiving a first type of PDSCH according to an embodiment of the disclosure.

Below is described an implementation in which upon reception of the first information, when detection of the first type of PDCCH and reception of the first type of PDSCH by the UE have been activated, the detection of the first type of PDCCH and the reception of the first type of PDSCH are performed respectively, according to the activation condition of the serving cell in which the first type of PDCCH is detected and the first type of PDSCH is received and the activation condition of the BWP in which the first type of PDCCH is detected and the first type of PDSCH is received. Referring to FIG. 13, the implementation specifically includes at least one of the following:

if the serving cell in which the first type of PDCCH is detected and the first type of PDSCH is received is an activated serving cell, and an activated BWP A in the activated serving cell is the BWP in which the first type of PDCCH is detected and the first type of PDSCH is received, detecting the first type of PDCCH in a first PDCCH search space in the activated BWP A;

if the serving cell in which the first type of PDCCH is detected and the first type of PDSCH is received is an activated serving cell, but an activated BWP A in the activated serving cell is not the BWP in which the first type of PDCCH is detected and the first type of PDSCH is received, switching from the currently activated BWP A to BWP B in which the first type of PDCCH is detected and the first type of PDSCH is received, and changing the BWP B in which the first type of PDCCH is detected and the first type of PDSCH is received into be the activated BWP B and detecting the first type of PDCCH in the activated BWP B; and

if the serving cell in which the first type of PDCCH is detected and the first type of PDSCH is received is a non-activated serving cell, activating the serving cell, and activating BWP B in which the first type of PDCCH is detected and the first type of PDSCH is received, and detecting the first type of PDCCH in the activated BWP B.

Further, if detecting the second type of PDCCH and receiving the second type of PDSCH is configured in the BWP B, the second type of PDCCH is detected in the activated BWP B;

if the activated BWP A in the activated serving cell and the BWP B in which the first type of PDCCH is detected and the first type of PDSCH is received are a BWP pair, and the activated BWP B is contained in the activated BWP A, the second type of PDCCH is detected in a second PDCCH search space in the activated BWP A.

The following is a description of the above scenarios:

First Scenario:

the serving cell in which the first type of PDCCH is detected and the first type of PDSCH is received is an activated serving cell, and an activated BWP A in the activated serving cell is the BWP in which the first type of PDCCH is detected and the first type of PDSCH is received.

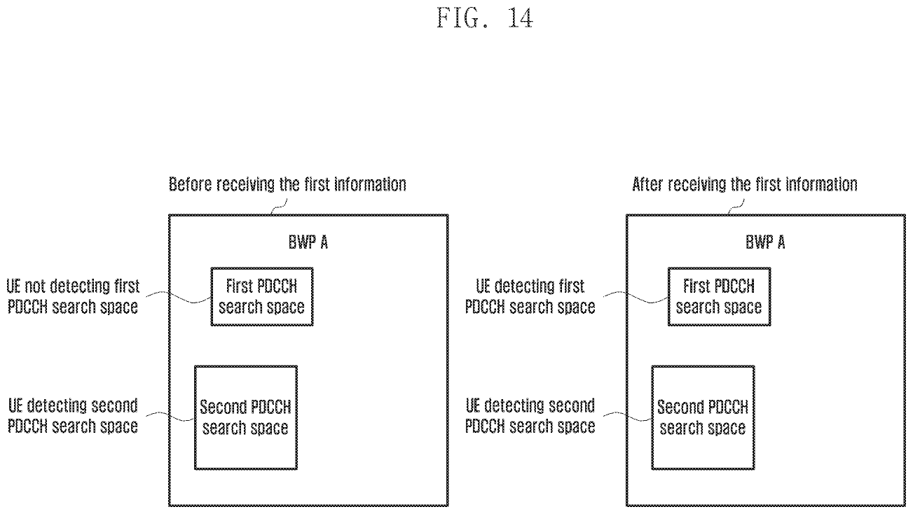

FIG. 14 is a schematic diagram of a scenario in which a first type of PDCCH is detected and a first type of PDSCH is received according to an embodiment of the disclosure.

When the first information indicates to activate the detection of the first type of PDCCH and reception of the first type of PDSCH, if the serving cell in which the UE detects the first type of PDCCH and receives the first type of PDSCH is an activated serving cell, and an activated BWP A in the activated serving cell is the BWP in which the first type of PDCCH is detected and the first type of PDSCH is received, detecting the first type of PDCCH and receiving the first type of PDSCH is started in the first PDCCH search space (search space for the first type of PDCCH) in the activated BWP A. Before receiving the first information, since BWP A is an activated BWP, the UE has detected the second type of PDCCH and received the second type of PDSCH in the second PDCCH search space (search space for the second type of PDCCH) in the BWP A. After receiving the first information, while the UE detects the first type of PDCCH and receives the first type of PDSCH in the first PDCCH search space, it detects the second type of PDCCH and receives the second type of PDSCH in the second PDCCH search space in BWP A, referring to FIG. 14.

Second Scenario:

the serving cell in which the first type of PDCCH is detected and the first type of PDSCH is received is an activated serving cell, but the activated BWP A in the activated serving cell is not the BWP in which the first type of PDCCH is detected and the first type of PDSCH is received.

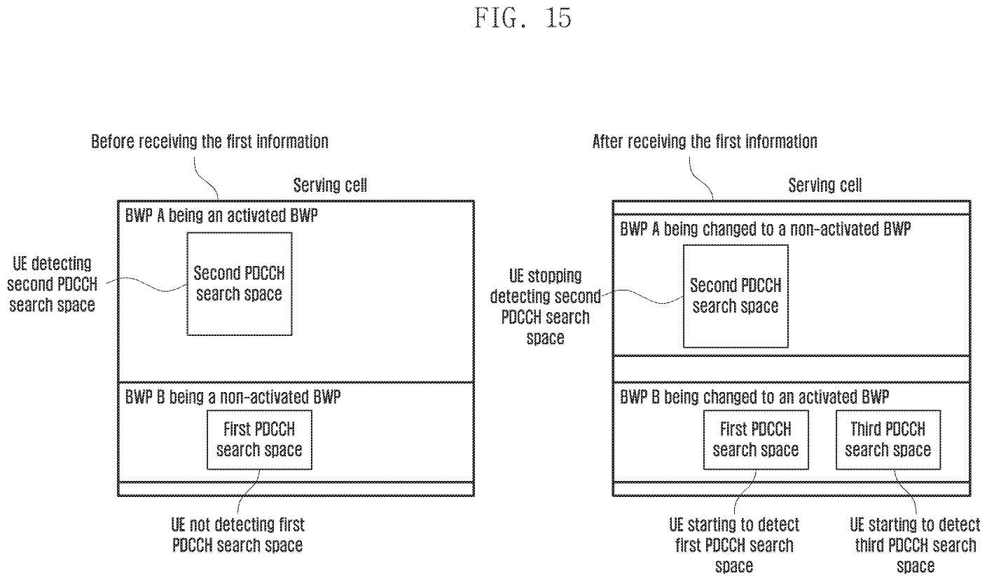

FIG. 15 is a schematic diagram of a scenario in which a first type of PDCCH is detected and a first type of PDSCH is received according to an embodiment of the disclosure.

When the first information indicates to activate the detection of the first type of PDCCH and the reception of the first type of PDSCH, if the serving cell in which the UE detects the first type of PDCCH and receives the first type of PDSCH is an activated serving cell, and the activated BWP A in the activated serving cell is not the BWP in which the first type of PDCCH is detected and the first type of PDSCH is received, switching from the currently activated BWP A to the BWP B in which the first type of PDCCH is detected and the first type of PDSCH is received is performed, the BWP B in which the first type of PDCCH is detected and the first type of PDSCH is received is changed to an activated BWP, and detecting the first type of PDCCH and receiving the first type of PDSCH are performed in the activated BWP B. Before receiving the first information, since the BWP A is an activated BWP, the UE has detected the second type of PDCCH and received the second type of PDSCH in the second PDCCH search space in BWP A. After receiving the first information, the activated BWP is changed from the BWP A to BWP B, it is impossible for the UE to detect the second type of PDCCH and receive the second type of PDSCH in the second PDCCH search space in BWP A. One method is for the UE to detect the first type of PDCCH and receive the first type of PDSCH in the BWP B, and at the same time, if the UE is configured to detect the second type of PDCCH and receive the second type of PDSCH in the BWP B, the UE detects the second type of PDCCH and receives the second type of PDSCH in a third PDCCH search space in BWP B, referring to FIG. 15. The advantage of adopting this method is that the UE can continue to detect the unicast PDCCH (the second type of PDCCH) while activating the detection of the multicast PDCCH (the first type of PDCCH).

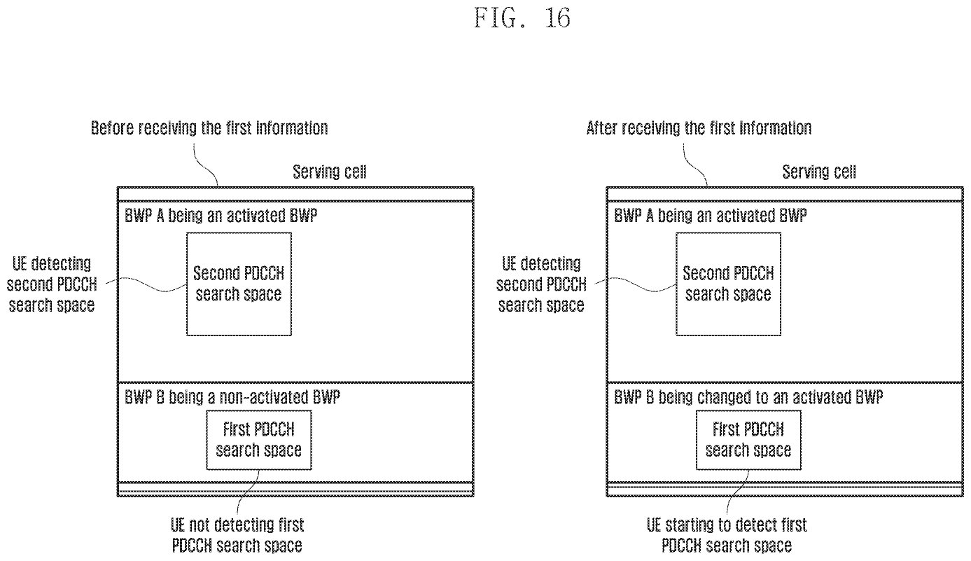

FIG. 16 is a schematic diagram of a scenario in which a first type of PDCCH is detected and a first type of PDSCH is received according to an embodiment of the disclosure.

Alternatively, the serving cell in which the first type of PDCCH is detected and the first type of PDSCH is received is an activated serving cell, the activated BWP A in the activated serving cell is not the BWP in which the first type of PDCCH is detected and the first type of PDSCH is received, but the activated BWP A in the activated serving cell and the BWP B in which the first type of PDCCH is detected and the first type of PDSCH is received is a BWP pair, and the activated BWP B is contained in the activated BWP A, the UE may perform detection in both BWP A and BWP B of the BWP pair, or a BWP switch delay is not needed in the UE's switching from the BWP B in which the first type of PDCCH is detected and the first type of PDSCH is received to the BWP in which the second type of PDCCH is detected and the second type of PDSCH is received. Before receiving the first information, since the BWP A is an activated BWP, the UE has detected the second type of PDCCH and received the second type of PDSCH in the second PDCCH search space in the BWP A. After receiving the first information, the UE may detect the second type of PDCCH and receive the second type of PDSCH in the BWP A and also may detect the first type of PDCCH and receive the first type of PDSCH in the BWP B, referring to FIG. 16. The advantage of adopting this method is that the UE can detect the first type of PDCCH and the second type of PDCCH at the same time, that is, the UE can receive multicast (first type) and unicast (second type) services simultaneously.

Third Scenario:

When the first information indicates to activate the detection of the first type of PDCCH and reception of the first type of PDSCH, if the serving cell in which the UE detects the first type of PDCCH and receives the first type of PDSCH is a non-activated serving cell, then the serving cell is activated, and the BWP B in which the first type of PDCCH is detected and the first type of PDSCH is received is activated, and the first type of PDCCH is detected and the first type of PDSCH is received, in the activated BWP B.

Alternatively, while in the activated BWP B, the first type of PDCCH is detected and the first type of PDSCH is received, the detection of the second type of PDCCH and the reception of the second type of PDSCH in the activated BWP B are activated.

Alternatively, the BWP B and BWP A are a BWP pair, and the activated BWP B is contained in the activated BWP A, the UE may perform detection in BWP A and BWP B of the BWP pair simultaneously, or a BWP switch delay is not needed in the UE's switching from the BWP B in which the first type of PDCCH is detected and the first type of PDSCH is received to the BWP in which the second type of PDCCH is detected and the second type of PDSCH is received, then while the first type of PDCCH is detected and the first type of PDSCH is received in the activated BWP B, the detection of the second type of PDCCH and the reception of the second type of PDSCH in the activated BWP A are activated.

Based on the foregoing embodiments of the disclosure, further, the PDSCH is received based on the detected PDCCH.

In the embodiment of the disclosure, the method of stopping receiving the PDSCH illustrated in FIG. 12 is implemented on the UE side. Specifically, after the second information is determined in operation S1201, operation S1202 may include the following operations:

stopping detecting the first type of PDCCH based on the second information;

receiving the first type of PDSCH based on the detected first type of PDCCH;

transmitting HARQ-ACK information for the first type of PDSCH.

It can be understood that after stopping detecting the first type of PDCCH, receiving the first type of PDSCH may be further stopped. For ease of description, the process may be directly referred to as stopping detecting the first type of PDCCH and receiving the first type of PDSCH in the below description.

The second information is at least one of physical layer signaling, media access layer signaling, higher layer signaling (higher layer signaling configuration information), or timer expiration information, wherein, for the physical layer signaling, media access layer signaling, or high layer signaling, the second information may be received.

An implementation in which the first information is physical layer signaling is described below.

For example, the UE stops the detection of the first type of PDCCH and reception of the first type of PDSCH by receiving the indication of the physical layer signaling.

An Optional Solution:

The physical layer signaling is DCI format x (DCI format x may be an existing DCI format, for example, DCI format 2-6, or a new DCI format). For example, the UE implements the transmission of the second information by receiving the DCI of the DCI format x. Based on the DCI format x, the first type of PDCCH may be detected through a Common Search Space. The DCI format x may be transmitted in the CSS of a primary cell of the UE, or in the CSS of a configured secondary cell.

In the embodiment of the disclosure, the DCI format x may be used to stop detecting the first type of PDCCH and receiving the first type of PDSCH by at least one UE.

In the embodiment of the disclosure, information transmitted in the DCI format x may include:

Information block 1, Information block 2, . . . , Information block N,

wherein, each UE may determine the location of its corresponding information block through the configuration of higher layer signaling.

In the embodiment of the disclosure, the second information include a stop indication.

For example, information in the information block of DCI format x may include:
stop indication 0, 1 bit.

In the embodiment of the disclosure, when the stop indication is a third preset value, the detection of the first type of PDCCH may be stopped;

when the stop indication is a fourth preset value, the corresponding information block is determined in the second information, and whether to stop detecting the first type of PDCCH is determined according to the stop indication in the information block.

Those skilled in the art could set the third preset value and the fourth preset value according to the actual scenarios. The embodiment of the disclosure does not pose any limitation in this regard. In an example, the third preset value may be 0 bit, and the fourth preset value may be 1 bit.

As an example, if the stop indication is 0 bit, once the UE receives the DCI of the DCI format x, it stops detecting the first type of PDCCH and receiving the first type of PDSCH. If the stop indication is 1 bit, after the UE receives the DCI of DCI format x, it finds the information block of the UE in the DCI. If the stop indication in the information block is ‘0’, the UE does not stop detecting the first type of PDCCH and receiving the first type of PDSCH, and if the stop indication in the information block is ‘1’, the UE stops detecting the first type of PDCCH and receiving the first type of PDSCH.

Another Optional Solution:

The physical layer signaling is DCI format y (DCI format y may be an existing DCI format, for example, DCI format 1-1, 0-1, or a new DCI format). DCI format y can be used to stop a UE to detect the first type of PDCCH. Based on the DCI format y, the first type of PDCCH may be detected through a UE-specific search space.

In the embodiment of the disclosure, the DCI format y may be distinguished according to the CRC, scrambled by the RNTI, of the DCI format y. For example, the DCI with the CRC scrambled by MBS-start-RNTI is DCI containing the second information, which is used to stop the detection of the first type of PDCCH and reception of the first type of PDSCH.

Alternatively, a DCI with a different size from the existing DCI is used to distinguish the DCI format y, which is used to stop the detection of the first type of PDCCH and reception of the first type of PDSCH.

Alternatively, a DCI of an existing DCI size is used to distinguish the DCI format y by setting a field in the DCI to a preset value, for example, xxxx, which is used to stop the detection of the first type of PDCCH and reception of the first type of PDSCH.

In the embodiment of the disclosure, the second information includes a stop indication.

For example, information for stopping detecting the first type of PDCCH and receiving the first type of PDSCH in the DCI format y may include:
stop indication 0, 1 bit.

In the embodiment of the disclosure, when the stop indication is a third preset value, the detection of the first type of PDCCH may be stopped;

when the stop indication is a fourth preset value, the corresponding information block is determined in the second information, and whether to stop detecting the first type of PDCCH is determined according to the stop indication in the information block.

Those skilled in the art could set the third preset value and the fourth preset value according to the actual scenarios. The embodiment of the disclosure does not pose any limitation in this regard. In an example, the third preset value may be 0 bit, and the fourth preset value may be 1 bit.

As an example, if the stop indication is 0 bit, once the UE receives the DCI of the DCI format y, it stops detecting the first type of PDCCH and receiving the first type of PDSCH. If the stop indication is 1 bit, after the UE receives the DCI of DCI format y, it finds the information block of the UE in the DCI. If the stop indication in the information block is ‘0’, the UE does not stop detecting the first type of PDCCH and receiving the first type of PDSCH, and if the stop indication in the information block is ‘1’, the UE stops detecting the first type of PDCCH and receiving the first type of PDSCH.

An implementation in which the second information is media access layer signaling is described below.

For example, the UE stops the detection of the first type of PDCCH and reception of the first type of PDSCH by receiving the indication of the media access layer signaling (the indication information of the media access layer).

In the embodiment of the disclosure, the second information includes stop indication.

For example, the second information in the media access layer signaling may include:
stop indication 0, 1 bit.

In the embodiment of the disclosure, when the stop indication is a third preset value, the detection of the first type of PDCCH may be stopped;

when the stop indication is a fourth preset value, the corresponding information block is determined in the second information, and whether to stop detecting the first type of PDCCH is determined according to the stop indication in the information block.

Those skilled in the art could set the third preset value and the fourth preset value according to the actual scenarios. The embodiment of the disclosure does not pose any limitation in this regard. In an example, the third preset value may be 0 bit, and the fourth preset value may be 1 bit.

As an example, if the stop indication is 0 bit, once the UE receives the indication information of the media access layer signaling, it stops detecting the first type of PDCCH and receiving the first type of PDSCH. If the stop indication is 1 bit, after the UE receives the indication information of the media access layer signaling, it finds the information block of the UE in the indication information. If the stop indication in the information block is ‘0’, the UE does not stop detecting the first type of PDCCH and receiving the first type of PDSCH, and if the stop indication in the information block is ‘ l’, the UE stops detecting the first type of PDCCH and receiving the first type of PDSCH.

An implementation in which the second information is higher layer signaling is described below.

For example, the UE stops the detection of the first type of PDCCH and reception of the first type of PDSCH by receiving the indication of the higher layer signaling.

In the embodiment of the disclosure, the second information includes stop indication.

For example, the second information of the higher layer signaling may include:
stop indication 0, 1 bit.

In the embodiment of the disclosure, when the stop indication is a third preset value, the detection of the first type of PDCCH may be stopped;

when the stop indication is a fourth preset value, the corresponding information block is determined in the second information, and whether to stop detecting the first type of PDCCH is determined according to the stop indication in the information block.

Those skilled in the art could set the third preset value and the fourth preset value according to the actual scenarios. The embodiment of the disclosure does not pose any limitation in this regard. In an example, the third preset value may be 0 bit, and the fourth preset value may be 1 bit.

As an example, if the stop indication is 0 bit, once the UE receives the indication information of the high layer signaling, it stops detecting the first type of PDCCH and receiving the first type of PDSCH. If the stop indication is 1 bit, after the UE receives the indication information of the high layer signaling, it finds the information block for the UE in the indication information. If the stop indication in the information block is ‘0’, the UE does not stop detecting the first type of PDCCH and receiving the first type of PDSCH, and if the stop indication in the information block is ‘1’, the UE stops detecting the first type of PDCCH and receiving the first type of PDSCH.

An implementation in which the second information is timer expiration information is described below.

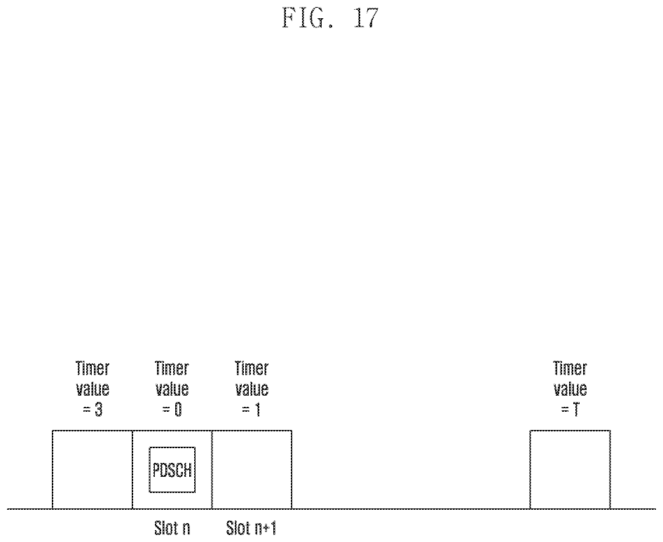

FIG. 17 is a schematic diagram of stopping detecting the first type of PDCCH and receiving the first type of PDSCH according to timer expiration according to an embodiment of the disclosure.

The UE may stop detecting the first type of PDCCH and receiving the first type of PDSCH according to expiration of Timer. If the Timer expires, detecting the first type of PDCCH and receiving the first type of PDSCH are stopped, and the Timer may be referred to as an MBS Timer, that is, if the UE does not receive the PDSCH (or PDCCH) within a time interval (T), it is considered that the Timer has expired. This Timer is only for the first type of PDCCH and receiving the first type of PDSCH. For example, referring to FIG. 17, the UE receives the first type of PDSCH scheduled by the first type of PDCCH in slot n, no matter what the previous Timer value is (for example, Timer=3), the Timer restarts, that is, the Timer value becomes “0”; in slot n+1, the UE does not receive the first type of PDSCH, and Timer=Timer+1, and so on, until the Timer value is equal to a threshold value T, at which point it is called Timer expired. By adopting this method, the detection of the groupcast/multicast PDCCH can be stopped timely when the groupcast/multicast service is stopped (the detection of the first type of PDCCH is stopped), and the power consumption of the UE is saved.

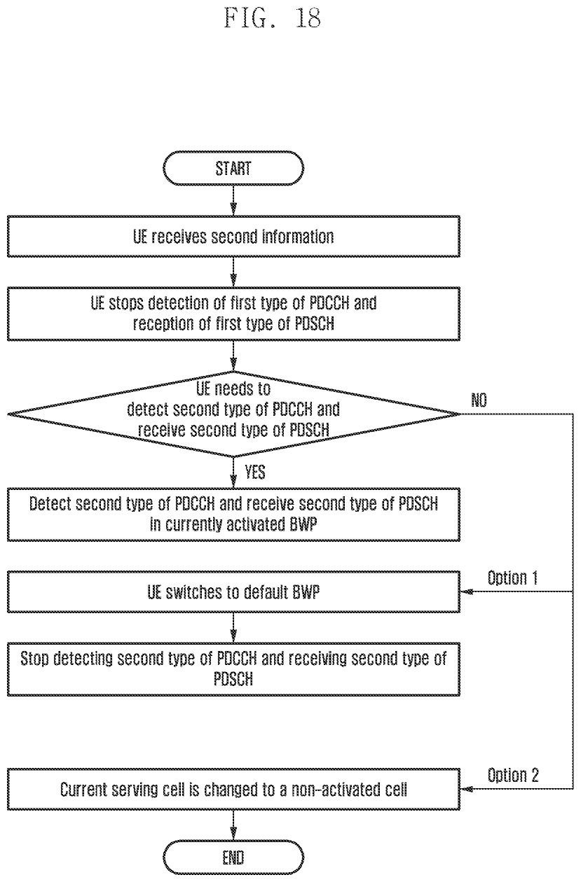

FIG. 18 is a schematic diagram after stopping detecting the first type of PDCCH and receiving the first type of PDSCH according to an embodiment of the disclosure.

An implementation occurs when the UE has received the second information and after detecting the first type of PDCCH and receiving the first type of PDSCH have been stopped is described below. Referring to FIG. 18, it further includes at least one of the following:

if the second type of PDCCH needs to be detected, detecting the second type of PDCCH in the second PDCCH search space in the currently activated BWP; and

if there is no need to detect the second type of PDCCH, switching the BWP in the serving cell in which the first type of PDCCH is detected and the first type of PDSCH is received to default BWP, or changing the serving cell in which the first type of PDCCH is detected and the first type of PDSCH is received to a non-activated serving cell.

The above scenarios are described below:

First Scenario:

After the UE stops detecting the first type of PDCCH and receiving the first type of PDSCH, if the UE continues to detect the second type of PDCCH and receiving the second type of PDSCH, it may stop detecting the first type of PDCCH in the first PDCCH search space and still detect the second type of PDCCH in the second PDCCH search space.

Whether the UE continues to detect the second type of PDCCH and receive the second type of PDSCH in the currently activated BWP may be determined according to whether another BWP inactivity Timer for the second type of PDSCH has expired, or whether other timers have expired.

Second Scenario:

After the UE stops detecting the first type of PDCCH and receiving the first type of PDSCH, if the UE does not continue to detect the second type of PDCCH and receive the second type of PDSCH, method 1 is: switching to the default BWP. Alternatively, after the UE stops detecting the first type of PDCCH and receiving the first type of PDSCH, if the UE does not continue to detect the second type of PDCCH and receive the second type of PDSCH, method 2 is that: the serving cell in which detecting the first type of PDCCH and receiving the first type of PDSCH are performed may be changed to a non-activated serving cell.

In the embodiment of the disclosure, whether to adopt method 1 or method 2 may be determined according to the state of the serving cell in which the first type of PDCCH is detected and the first type of PDSCH is received before the UE activates the detection of the first type of PDCCH and reception of the first type of PDSCH. The method specifically includes: adopting method 2, if the serving cell in which the first type of PDCCH is detected and the first type of PDSCH is received is a non-activated serving cell before the UE activates the detection of the first type of PDCCH and reception of the first type of PDSCH; and adopting method 1, if the serving cell in which the first type of PDCCH is detected and the first type of PDSCH is received is an activated serving cell before the UE activates the detection of the first type of PDCCH and reception of the first type of PDSCH.

In the embodiment of the disclosure, a timing relationship needs to be determined to activate or stop detecting the first type of PDCCH. For example, the UE receives a command to activate or stop detecting the first type of PDCCH in slot n, and activates or stops detecting the first type of PDCCH in slot n+k.

Specifically, in operation S1102, the operation of activating the detection of the first type of PDCCH based on the first information includes: determining a second slot in which the detection of the first type of PDCCH is activated according to a first timing relationship and a first slot in which the first information is received; and detecting the first type of PDCCH in the second slot; wherein the first timing relationship is determined according to whether the serving cell in which the first type of PDCCH is detected is in an activated state and/or whether the BWP in which the first type of PDCCH is detected is an activated BWP.

In operation S1202, the operation of stopping detecting the first type of PDCCH based on the second information includes: determining a fourth slot in which detecting the first type of PDCCH is stopped according to a second timing relationship and a third slot in which the second information is received; and stopping detecting the first type of PDCCH in the fourth slot, wherein the second timing relationship is determined according to an information type of the second information.

The timing relationships of activating and stopping detecting the first type of PDCCH are described below respectively.

The timing relationships of activating the detection of the first type of PDCCH, that is, the UE receives a command to activate the detection of the first type of PDCCH in slot n, and activates the detection of the first type of PDCCH in slot n+k1, include following scenarios:

First Scenario:

If the serving cell in which the first type of PDCCH is detected is in an inactivated state, at this time, the time required to activate the serving cell is relatively long. At this time, k1 is k1_1, and the UE may determine the value of k1_1 by receiving higher layer signaling configuration or presetting it.

Second Scenario:

If the serving cell in which the first type of PDCCH is detected is in an inactivated state, but the BWP in which the first type of PDCCH is detected is not an activated BWP, the UE needs to be switched to the BWP in which the first type of PDCCH is detected. At this time, k1 is k1_2, and the UE may determine the value of k1_2 by receiving higher layer signaling configuration or presetting it.

Third Scenario:

If the serving cell in which the first type of PDCCH is detected is in an activated state, and the BWP in which the first type of PDCCH is detected is an activated BWP, at this time, k1 is k1_3, and the UE may determine the value of k1_3 by receiving higher layer signaling configuration or presetting it.

The above k1_1, k1_2, and k1_3 may be determined independently, such that the detection of the first type of PDCCH can be started as soon as possible according to the time required for different scenarios. At least two of the above k1_1, k1_2, and k1_3 may be determined to be the same. For example, k1_1 and k1_2 are of one value, which can reduce signaling overhead. The k1_1, k1_2, and k1_3 mentioned above are expressed in a manner, and k1_2=k1_1+offset_1, k1_3=k1_1+offset_2 may also be possible.

The timing relationships of stopping the detection of the first type of PDCCH, that is, the UE receives a command to stop the detection of the first type of PDCCH in slot n, and stops the detection of the first type of PDCCH in slot n+k2, include the following scenarios.

First Scenario:

If the UE stops detecting the first type of PDCCH by receiving the indication of the DCI information, at this time, the k2 is k2_1, and the UE may determine the value of k2_1 by receiving higher layer signaling configuration or presetting it.

Second Scenario:

If the UE stops detecting the first type of PDCCH by receiving the indication of the media access layer signaling or the higher layer signaling, at this time, the k2 is k2_2, and the UE may determine the value of k2_2 by receiving higher layer signaling configuration or presetting it.

Below is described an implementation in which if the activation or stop of the detection of the first type of PDCCH and the reception of the first type of PDSCH is implemented by the indication of the DCI or media access layer signaling, and the activation or stop by the DCI is for a group of UEs, then HARQ-ACK is fedback with respect to the DCI or media access layer signaling.

In the embodiment of the disclosure, the first information is at least one of physical layer signaling or media access layer signaling, or the second information is at least one of physical layer signaling or media access layer signaling, and when the first information or the second information corresponds to at least two terminals, the following are further included:

when a state in which the first type of PDCCH is detected is changed, the HARQ-ACK for first information or second information is fedback; and

when the state in which the first type of PDCCH is detected is not changed, no HARQ-ACK for the first information or the second information is fedback.

Specifically, when the state in which the UE detects the first type of PDCCH and receives the first type of PDSCH is changed from being stopped to being activated, the UE would feedback HARQ-ACK; when the state in which the UE detects the first type of PDCCH and receives the first type of PDSCH is changed from being activated to being stopped, the UE would feedback HARQ-ACK; when the state in which the UE detects the first type of PDCCH and receives the first type of PDSCH is unchanged from being stopped, the UE does not feedback HARQ-ACK; and when the state in which the UE detects the first type of PDCCH and receives the first type of PDSCH is unchanged from being activated, the UE does not feedback HARQ-ACK. For example, there are two UEs, UE-1 and UE-2, respectively, that are configured to detect the first type of PDCCH and receive the first type of PDSCH; wherein, UE-1 and UE-2 are in the state in which detection of the first type of PDCCH and reception of the first type of PDSCH are activated. When a piece of indication information is received, which indicates that the UE-1 is changed from the state in which detection of the first type of PDCCH and reception of the first type of PDSCH are activated to the state in which detection of the first type of PDCCH and reception of the first type of PDSCH are stopped, and that the UE-2 is unchanged from the state in which detection of the first type of PDCCH and reception of the first type of PDSCH are activated. At this time, UE-1 feedbacks HARQ-ACK, and UE-2 does not feedback HARQ-ACK. Alternatively, there are two UEs, UE-1 and UE-2 respectively, that are configured to detect the first type of PDCCH and receive the first type of PDSCH; wherein, UE-1 and UE-2 are in the state in which detection of the first type of PDCCH and reception of the first type of PDSCH are stopped. When a piece of indication information is received, which indicates that the UE-1 is changed from the state in which detection of the first type of PDCCH and reception of the first type of PDSCH are stopped to the state in which detection of the first type of PDCCH and reception of the first type of PDSCH are activated, and that the UE-2 is unchanged from the state in which detection of the first type of PDCCH and reception of the first type of PDSCH are stopped. At this time, UE-1 feedbacks HARQ-ACK, and UE-2 does not feedback HARQ-ACK. The advantage of this method is that the base station may be informed of the reception condition of the state changing information on detection of the first type of PDCCH and reception of the first type of PDSCH, and it can also enable the UE for which the state of detecting the first type of PDCCH and receiving the first type of PDSCH is not changed, to save resources fedback by HARQ-ACK and power consumption.

Below is described an implementation of switching the BWP, which may be used for the scenarios where there are at least two search spaces at the same time.

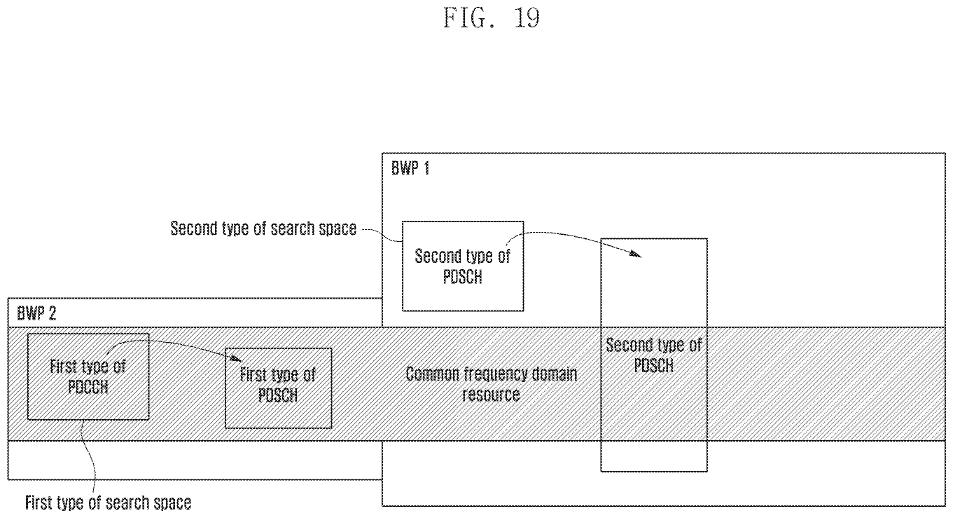

FIG. 19 is a schematic diagram of switching a BWP according to an embodiment of the disclosure.

When the UE is configured with at least two Search Spaces (SSs) in a serving cell or a BWP or a BWP pair, wherein the search space corresponding to the frequency domain resources located in a certain frequency domain range is called a first type of search space; for example, referring to FIG. 19, the first type of PDSCH scheduled by the first type of PDCCH in the first type of search space is limited to the range of the common frequency domain resources in which it is located, while the second type of search space may be located in any frequency domain range of the entire BWP. For example, the first type of search space used to detect the first type of PDCCH is used to schedule the range of the common frequency domain resources, and the second type of PDSCH scheduled by the second type of PDCCH in the second type of Search Space may be in the entire range of BWP frequency domain resources.

In the embodiment of the disclosure, when there are at least two BWPs in which the first type of search space is included, and the frequency domain range of the first BWP currently located is larger than the frequency domain range of other BWPs, it further includes at least one of the following:

if a first timer for counting of the reception of the first type of PDSCH does not expire, and a second timer for counting of the reception of the second type of PDSCH expires, switching from the first BWP to another BWP, and detecting the first type of PDCCH in the switched-to BWP;

if both the first timer and the second timer expire, switching to a default BWP or an initial BWP; and

if the first timer expires and the second timer does not expire, stopping detecting the first type of PDCCH, or stopping detecting the first type of PDCCH in the first type of search space.

Specifically, when there are at least two BWPs in which common frequency domain resources are included, two timers may be defined, one of which is used to count the reception of the second type of PDSCH and is called a second timer, and the other of which is used to count the reception of the first type of PDSCH and is called a first timer. Taking the case where the base station configures two BWPs, the first BWP and the second BWP respectively, for the UE as an example, common frequency domain resources received by the first type of PDSCH (wherein the first BWP may be a BWP with a large frequency domain range, and the second BWP may be a BWP with a smaller frequency domain range) are included in each of the BWPs, and the UE is located in the configured first BWP. If the second timer expires but the first timer does not expire, the UE may switch from the first BWP to the configured second BWP, and the UE continues to detect the first type of PDCCH in the second BWP. As such, the UE receives the PDCCH and PDSCH in the smaller frequency range, which can save the power consumption of the UE. When the first timer expires and the second timer expires, the UE may switch to the default BWP or the initial BWP. When the first timer expires and the second timer does not expire, the UE may stop detecting the first type of PDCCH, and may also stop detecting the PDCCH in the first type of Search Space.

An implementation of switching the BWP is described below.

In the embodiment of the disclosure, when the first type of search space for detecting the first type of PDCCH is included in the BWP before being switched, and the state in which the first type of PDCCH is detected is activated, if the first type of search space is included in the switched-to BWP, the detection of the first type of PDCCH is activated in the switched-to BWP, and if the first type of search space is not included in the switched-to BWP, the first type of PDCCH is not detected in the switched-to BWP;

when the BWP before being switched and the BWP specific to the first type of PDCCH are a pair, and both are in the activated state, if the switched-to BWP and the BWP specific to the first type of PDCCH are a pair, the BWP specific to the first type of PDCCH paired with the switched-to BWP is changed to the activated state, and if the switched-to BWP is not a pair with the BWP specific to the first type of PDCCH, the first type of PDCCH is not detected after the BWP is switched.

Further, when the first type of PDCCH is not detected in the switched-to BWP, it includes at least one of the following:

the state in which the first type of PDCCH is detected being the activated state, if it is further switched to a new BWP in which the first type of search space is included, the first type of PDCCH is detected in the new BWP;

the state in which the first type of PDCCH is detected being the stopped state, if it is further switched to a new BWP in which the first type of search space is included, when there is no new activation indication, the first type of PDCCH is not detected in the new BWP.

Furthermore, when the first type of PDCCH is not detected after the BWP is switched, it includes at least one of the following:

the state in which the first type of PDCCH is detected being the activated state, if it is further switched to a third BWP in which the second type of PDCCH is detected, and the third BWP is a pair with the fourth BWP in which the first type of PDCCH is detected, the first type of PDCCH is detected in the fourth BWP;

the state in which the first type of PDCCH is detected being the stopped state, if it is further switched to the third BWP in which the second type of PDCCH is detected, and the third BWP is a pair with the fourth BWP in which the first type of PDCCH is detected, when there is no new activation indication, the first type of PDCCH is not detected in the fourth BWP.

Upon switching of the BWP, if the detection of the first type of PDCCH of the BWP before being switched is activated, that is, a search space for detecting the first type of PDCCH is included in the BWP before being switched, and the detection of the first type of PDCCH is in the activated state, and a search space for detecting the first type of PDCCH is included the switched-to BWP, the detection of the first type of PDCCH in the switched-to BWP is changed to the activated state.

Upon switching of the BWP, if the detection of the first type of PDCCH of the BWP before being switched is activated, that is, the search space for detecting the first type of PDCCH is included in the BWP before being switched, and the detection of the first type of PDCCH is in the activated state, and the search space for detecting the first type of PDCCH is not included in the switched-to BWP, the first type of PDCCH is not detected in the switched-to BWP. One method is that after the switching, the detection of the first type of PDCCH is still in the activated state, if the BWP is further switched to the BWP in which the search space for detecting the first type of PDCCH is included, the method proceeds with detecting the first type of PDCCH in the new switched-to BWP. Another method is that after the switching, the detection of the first type of PDCCH is in the stopped state, if the BWP is further switched to the BWP in which the search space for detecting the first type of PDCCH is included, if there is no new activation indication, the first type of PDCCH is not detected in the new switched-to BWP.

Upon switching of the BWP, if the detection of the first type of PDCCH in the BWP pair before being switched is activated, that is, the BWP before being switched and the first type of PDCCH-specific BWP are a pair, and both are in the activated state, the switched-to BWP and the first type of PDCCH-specific BWP is a pair, the first type of PDCCH-specific BWP paired with the switched-to BWP is changed to the activated state.

Upon switching of the BWP, if the detection of the first type of PDCCH in the BWP pair before being switched is activated, that is, the BWP before being switched and the first type of PDCCH-specific BWP are a pair, and both are in the activated state, the switched-to BWP and the first type of PDCCH-specific BWP are not a pair, the first type of PDCCH is not detected after the BWP is switched. One method is that after the switching, the detection of the first type of PDCCH is still in the activated state, if it is further switched to the BWP (that is, the third BWP) paired with the first type of PDCCH-specific BWP (that is, the fourth BWP), the method proceeds with detecting the first type of PDCCH in the new first type of PDCCH-specific BWP. Another method is that after the switching, the detection of the first type of PDCCH is in the stopped state, if it is further switched to the BWP paired with the first type of PDCCH-specific BWP, if there is no new activation indication, the first type of PDCCH is not detected in the new first type of PDCCH-specific BWP.

With the above methods, the reception of the multicast service can be quickly started without additional signaling.

In an embodiment of the disclosure, the above-mentioned embodiments may be applied to the MBS. In one embodiment of the disclosure, the first type of PDSCH is a groupcast/multicast PDSCH, and the second type of PDSCH is a unicast PDSCH. In other embodiments of the disclosure, other types of PDSCHs may also be used. Similarly, the first type of PDCCH is a groupcast/multicast PDCCH, and the second type of PDCCH is a unicast PDCCH.

The methods for starting (activating) and ending (stopping) receiving the groupcast/multicast PDSCH provided by the embodiments of the disclosure can start and end reception of the groupcast/multicast PDSCH in time, and save the power consumption of the UE as much as possible.

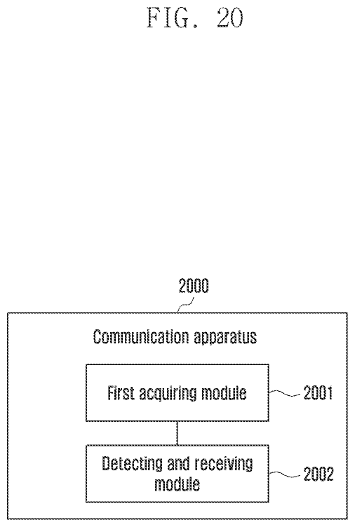

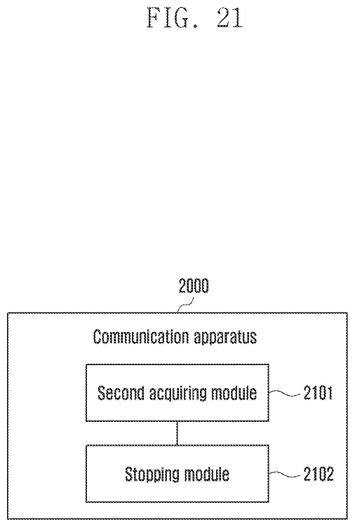

FIG. 20 is a schematic structural diagram of a communication apparatus according to an embodiment of the disclosure. FIG. 21 is a schematic structural diagram of another communication apparatus according to an embodiment of the disclosure.

An embodiment of the disclosure also provides a communication apparatus. Referring to FIG. 20, the communication apparatus 2000 may include: a first acquiring module 2001 and a detecting and receiving module 2002, wherein:

the first acquiring module 2001 is used for acquiring first information for activating detection of a first type of PDCCH;

the detecting and receiving module 2002 is used for detecting the first type of PDCCH, and receiving the first type of PDSCH according to the first type of PDCCH.

Alternatively, referring to FIG. 21, the communication apparatus 2000 may include: a second acquiring module 2101 and a stopping module 2102, wherein:

the second acquiring module 2101 is used for acquiring second information for stopping the detection of the first type of PDCCH;

the stopping module 2102 is used for stopping detecting the first type of PDCCH.

In an optional implementation, the first information is at least one of physical layer signaling, media access layer signaling, higher layer signaling, or reference signal indication information; and/or

the second information is at least one of physical layer signaling, media access layer signaling, higher layer signaling, or timer expiration information.

In an optional implementation, the physical layer signaling is DCI format x or DCI format y.

In an optional implementation, the first information includes at least one of the following:

activation indication;

configuration information for detecting the first type of PDCCH;

configuration information for receiving the first type of PDSCH.

In an optional implementation, when the detecting and receiving module 2002 is used for detecting the first type of PDCCH, it is specifically used for:

when the activation indication is a first preset value, detecting the first type of PDCCH;

when the activation indication is a second preset value, determining a corresponding information block in the first information, and determining whether to detect the first type of PDCCH according to the activation indication in the information block.

In an optional implementation, when the detecting and receiving module 2002 is used for detecting the first type of PDCCH, it is specifically used for:

when there are at least two sets of configurations for detecting the first type of PDCCH, determining a configuration for detecting the first type of PDCCH to be used according to the configuration information for detecting the first type of PDCCH, and detecting the first type of PDCCH according to the determined configuration for detecting the first type of PDCCH.

In an optional implementation, a number of bits of the configuration information for detecting the first type of PDCCH is determined according to a number of configurations for detecting the first type of PDCCH.

In an optional implementation, when the first information is higher layer signaling, when the detecting and receiving module 2002 is used for detecting the first type of PDCCH, it is specifically used for:

when there are at least two sets of configurations for detecting the first type of PDCCH, detecting the first type of PDCCH according to a configuration for detecting the first type of PDCCH indicated by the higher layer signaling.

In an optional implementation, the configuration information for detecting the first type of PDCCH and the configuration information for receiving the first type of PDSCH includes at least one of the following:

a serving cell in which the first type of PDCCH is detected and the first type of PDSCH is received;

downlink bandwidth part BWP in which the first type of PDCCH is detected and the first type of PDSCH is received;

a frequency domain position of a resource for detecting the first type of PDCCH and receiving the first type of PDSCH, in the downlink BWP;

configuration information for a control resource set for detecting the first type of PDCCH;

configuration information for a search space for detecting the first type of PDCCH;

configuration information for receiving the first type of PDSCH.

In an optional implementation, when the detecting and receiving module 2002 is used for detecting the first type of PDCCH, it is specifically used for at least one of the following:

if the serving cell in which the first type of PDCCH is detected and the first type of PDSCH is received is an activated serving cell, and an activated BWP A in the activated serving cell is the BWP in which the first type of PDCCH is detected and the first type of PDSCH is received, detecting the first type of PDCCH in a first PDCCH search space in the activated BWP A;

if the serving cell in which the first type of PDCCH is detected and the first type of PDSCH is received is an activated serving cell, but an activated BWP A in the activated serving cell is not the BWP in which the first type of PDCCH is detected and the first type of PDSCH is received, switching from the currently activated BWP A to BWP B in which the first type of PDCCH is detected and the first type of PDSCH is received, and changing the BWP B in which the first type of PDCCH is detected and the first type of PDSCH is received to be the activated BWP B, and detecting the first type of PDCCH in the activated BWP B;

if the serving cell in which the first type of PDCCH is detected and the first type of PDSCH is received is a non-activated serving cell, activating the serving cell, and activating BWP B in which the first type of PDCCH is detected and the first type of PDSCH is received, and detecting the first type of PDCCH in the activated BWP B.

In an optional implementation, when the detecting and receiving module 2002 is used for detecting the first type of PDCCH in the activated BWP B, it is specifically used for at least one of the following:

if detecting a second type of PDCCH and receiving a second type of PDSCH is configured in the BWP B, detecting the second type of PDCCH in the activated BWP B;

if the activated BWP A in the activated serving cell and the BWP B in which the first type of PDCCH is detected and the first type of PDSCH is received are a BWP pair, and the activated BWP B is contained in the activated BWP A, detecting the second type of PDCCH in a second PDCCH search space in the activated BWP A.

In an optional implementation, the second information includes a stop indication, and when the stopping module 2102 is used for stopping detecting the first type of PDCCH, it is specifically used for at least one of the following:

when the stop indication is a third preset value, stopping detecting the first type of PDCCH;

when the stop indication is a fourth preset value, determining a corresponding information block in the second information, and determining whether to stop detecting the first type of PDCCH according to the stop indication in the information block.

In an optional implementation, after the stopping module 2102 is used for stopping detecting the first type of PDCCH, it is further used for at least one of the following:

if the second type of PDCCH needs to be detected, detecting the second type of PDCCH in the second PDCCH search space of the currently activated BWP;

if there is no need to detect the second type of PDCCH, switching the BWP in the serving cell in which the first type of PDCCH is detected and the first type of PDSCH is received to a default BWP, or changing the serving cell in which the first type of PDCCH is detected and the first type of PDSCH is received to a non-activated serving cell.

In an optional implementation, when the detecting and receiving module 2002 is used for detect the first type of PDCCH, it is specifically used for:

determining a second slot in which the first type of PDCCH is detected according to a first timing relationship and a first slot in which the first information is received;

detecting the first type of PDCCH in the second slot;

When the stopping module 2102 is used for stopping detecting the first type of PDCCH, it is specifically used for:

determining a fourth slot of stopping detecting the first type of PDCCH according to a second timing relationship and a third slot in which the second information is received;

stopping detecting the first type of PDCCH in the fourth slot.

In an optional implementation, the first timing relationship is determined according to whether the serving cell in which the first type of PDCCH is detected is in an activated state and/or whether the BWP in which the first type of PDCCH is detected is an activated BWP.

The second timing relationship is determined according to an information type of the second information.

In an optional implementation, when the first information or the second information corresponds to at least two terminals, the communication apparatus 2000 further includes a feedback module for:

when a state in which the first type of PDCCH is detected is changed, feeding back the HARQ-ACK for the first information or the second information;

when the state in which the first type of PDCCH is detected is not changed, not feeding back the HARQ-ACK of the first information or the second information.

In an optional implementation, when there are at least two BWPs in which the first type of search space is included, and the frequency domain range of the first BWP currently located is larger than the frequency domain range of other BWPs, the detecting and receiving module 2002 or the stopping module 2102 is further used for at least one of the following:

if a first timer for counting the reception of the first type of PDSCH does not expire, and a second timer for counting the reception of the second type of PDSCH expires, switching from the first BWP to another BWP, and detecting the first type of PDCCH in the switched-to BWP;

if both the first timer and the second timer expire, switching to the default BWP or the initial BWP;

if the first timer expires and the second timer does not expire, stopping detecting the first type of PDCCH, or stopping detecting the first type of PDCCH in the first type of search space.

In an optional implementation, when the BWP is switched, the detecting and receiving module 2002 or the stopping module 2102 is further used for at least one of the following:

when the first type of search space for detecting the first type of PDCCH is included in the BWP before being switched, and the state in which the first type of PDCCH is detected is activated, if the first type of search space is included in the switched-to BWP, activating the detection of the first type of PDCCH in the switched-to BWP, and if the first type of search space is not included in the switched-to BWP, not detecting the first type of PDCCH in the switched-to BWP;

when the BWP before being switched and the BWP specific to the first type of PDCCH are a pair, and both are in the activated state, if the switched-to BWP and the BWP specific to the first type of PDCCH are a pair, changing the BWP specific to the first type of PDCCH paired with the switched-to BWP to the activated state, and if the switched-to BWP is not a pair with the BWP specific to the first type of PDCCH, not detecting the first type of PDCCH after the BWP is switched.

In an optional implementation, when the first type of PDCCH is not detected in the switched-to BWP, the detecting and receiving module 2002 or the stopping module 2102 is used for at least one of the following:

the state in which the first type of PDCCH is detected being the activated state, if it is further switched to a new BWP in which the first type of search space is included, the first type of PDCCH is detected in the new BWP;

the state in which the first type of PDCCH is detected being the stopped state, if it is further switched to a new BWP in which the first type of search space is included, when there is no new activation indication, the first type of PDCCH is not detected in the new BWP.

When the first type of PDCCH is not detected after the BWP is switched, the detecting and receiving module 2002 or the stopping module 2102 is used for at least one of the following:

the state in which the first type of PDCCH is detected being the activated state, if it is further switched to a third BWP in which the second type of PDCCH is detected, and the third BWP is a pair with the fourth BWP in which the first type of PDCCH is detected, the first type of PDCCH is detected in the fourth BWP;

the state in which the first type of PDCCH is detected being the stopped state, if it is further switched to the third BWP in which the second type of PDCCH is detected, and the third BWP is a pair with the fourth BWP in which the first type of PDCCH is detected, when there is no new activation indication, the first type of PDCCH is not detected in the fourth BWP.

In an optional implementation, the first type of PDCCH is a groupcast/multicast PDCCH, and the second type of PDCCH is a unicast PDCCH.

Those skilled in the art can clearly understand that the implementation principles and technical effects of the communication apparatus provided in the embodiments of the disclosure are the same as those of the foregoing method embodiments. For the convenience and conciseness of the description, please refer to the corresponding content in the foregoing method embodiments for the content not mentioned in these embodiments of the disclosure, which will not be repeated here.

An embodiment of the disclosure also provides an electronic device (such as a terminal device), including: a processor and a memory, the memory storing at least one instruction, at least one segment of program, code set, or instruction set, the at least one instruction, at least one segment of program, code set or instruction set is loaded and executed by the processor to implement the corresponding content in the foregoing method embodiments.

Alternatively, the electronic device may further include a transceiver. The processor and the transceiver are connected, such as through a bus. It should be noted that in actual applications, the transceiver is not limited to one, and the structure of the electronic device does not constitute a limitation to the embodiments of the disclosure.

Wherein the processor may be a central processing unit (CPU), a general-purpose processor, digital signal processor (DSP), application specific integrated circuits (ASIC), field programmable gate arrays (FPGA) or other programmable logic devices, transistor logic devices, hardware components, or any combination thereof. It can implement or execute various logical blocks, modules, and circuits described in conjunction with the disclosure of this application. The processor may also be a combination of implementing computing functions, for example, a combination of one or more microprocessors, a combination of a DSP and a microprocessor, and the like.

The bus may include a path to transfer information between the above-mentioned components. The bus may be a peripheral component interconnect (PCI) bus or an extended industry standard architecture (EISA) bus. The bus may include address bus, data bus, control bus and the like. The memory may be read only memory (ROM) or other types of static storage devices that can store static information and instructions, random access memory (RAM) or other types of dynamic storage devices that can store information and instructions, or it may be electrically erasable programmable read-only memory (EEPROM), compact disc (CD)-ROM or other optical disk storage, optical disk storage (including compact discs, laser discs, optical discs, digital versatile discs, Blu-ray discs, and the like), magnetic disk storage media or other magnetic storage devices, or any other media that can be used to carry or store desired program codes in the form of instructions or data structures and can be accessed by a computer, but is not limited to this.

The embodiments of the disclosure also provide a computer-readable storage medium, which is used to store computer instructions, which, when running on a computer, enable the computer to implement the corresponding content in the foregoing method embodiments.

It should be understood that while the various operations in the flowchart of the drawings are illustrated in sequence as indicated by the arrows, these operations are not necessarily performed in sequence in the order indicated by the arrows. Unless explicitly stated herein, the performance of these operations are not strictly limited in the order, and they can be performed in other orders. Moreover, at least part of the operations in the flowchart of the drawings may include multiple sub-operations or multiple stages. These sub-operations or stages are not necessarily performed at the same point of time, but can be performed at different points of time, and the order of performance is not necessarily performed sequentially, but may be performed by turns or alternately with at least a part of other operations or sub-operations or stages of other operations.

The above are only the preferred embodiments of the disclosure and are not intended to limit the disclosure. Any modification, equivalent replacement, improvement, or the like, made within the spirit and principle of the disclosure shall be included in the protection scope of the disclosure.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment in a wireless communication system, the method comprising:
receiving control information from a base station;
receiving a plurality of pieces of downlink data from the base station, based on the control information;
determining, for the plurality of pieces of downlink data, a resource for transmitting hybrid automatic retransmission request acknowledgement (HARQ-ACK) information, based on the control information; and
transmitting the HARQ-ACK information to the base station on the determined resource,
wherein determining the resource for transmitting the HARQ-ACK information comprises:
determining, for each of the plurality of pieces of downlink data, a first resource or resource pair for transmitting the HARQ-ACK information, or
determining, for the plurality of pieces of downlink data, a second resource or resource pair for transmitting the HARQ-ACK information.

2. The method of claim 1, wherein, in a case of determining the second resource or resource pair for transmitting the HARQ-ACK information, the user equipment bundles the HARQ-ACK information for the plurality of pieces of downlink data and transmits the bundled HARQ-ACK information on the determined second resource or resource pair.

3. The method of claim 1, wherein the second resource or resource pair for transmitting the HARQ-ACK information is determined based on a predetermined rule.

4. The method of claim 1, wherein the second resource or resource pair for transmitting the HARQ-ACK information is selected from a set of resources for transmitting the HARQ-ACK information.

5. The method of claim 2,
wherein, if the bundled HARQ-ACK information is a negative acknowledgement NACK, the bundled HARQ-ACK information is transmitted on the determined second resource and if the bundled HARQ-ACK information is an acknowledgement ACK, the bundled HARQ-ACK information is not transmitted, or
wherein, if the bundled HARQ-ACK information is NACK, the bundled HARQ-ACK information is transmitted on one resource in the determined second resource pair, and if the bundled HARQ-ACK information is ACK, the bundled HARQ-ACK information is transmitted on the other resource in the determined second resource pair.

6. The method of claim 3, wherein the predetermined rule comprises the following:
when HARQ-ACK information for only one piece of downlink data among the plurality of pieces of downlink data is a negative acknowledgement NACK, a resource or resource pair corresponding to the HARQ-ACK information for the piece of downlink data is determined as the second resource or resource pair; and
when there is more than one piece of downlink data for which HARQ-ACK information is NACK among the plurality of pieces of downlink data, a resource or resource pair corresponding to one of the more than one piece of downlink data is determined as the second resource or resource pair.

7. The method of claim 6, wherein the determining of the resource or resource pair corresponding to one of the more than one piece of downlink data as the second resource or resource pair comprises:
determining a resource or resource pair corresponding to a chronologically first or last downlink data of the more than one piece of downlink data as the second resource or resource pair.

8. The method of claim 4, wherein the set of resources for transmitting HARQ-ACK information is determined based on a semi-static resource set determination approach or a dynamic resource set determination approach.

9. The method of claim 1,
wherein in a case of determining the first resource or resource pair for transmitting the HARQ-ACK information,
wherein the first resource or resource pair is determined based on information related to uplink resources included in the control information, or
wherein the first resource or resource pair is determined based on information related to uplink resources and information related to downlink allocation included in the control information.

10. The method of claim 1, wherein, in a case of determining the first resource or resource pair for transmitting the HARQ-ACK information, for each piece of downlink data:
if the HARQ-ACK information is a negative acknowledgement NACK, the HARQ-ACK information is transmitted on the determined first resource, and if the HARQ-ACK information is an acknowledgement ACK, the HARQ-ACK information is not transmitted; or
if the HARQ-ACK information is NACK, the HARQ-ACK information is transmitted on one resource in the determined first resource pair, and if the HARQ-ACK information is ACK, the HARQ-ACK information is transmitted on the other resource in the determined first resource pair.

11. The method of claim 1, wherein the user equipment and at least one other user equipment use the same first resource or resource pair or second resource or resource pair to transmit the HARQ-ACK information for the same downlink data.

12. A method performed by a base station in a wireless communication system, the method comprising:
transmitting control information to a user equipment;
transmitting a plurality of pieces of downlink data to the user equipment, based on the control information; and
receiving hybrid automatic retransmission request acknowledgement (HARQ-ACK) information from the user equipment on a resource for receiving the HARQ-ACK information,
wherein the resource is determined for the plurality of pieces of downlink data, based on the control information, and comprises:
a first resource or resource pair for transmitting the HARQ-ACK information determined for each of the plurality of pieces of downlink data, or
a second resource or resource pair for transmitting the HARQ-ACK information determined for the plurality of pieces of downlink data.

13. The method of claim 12, wherein, in a case of determining the second resource or resource pair for transmitting the HARQ-ACK information, the user equipment bundles the HARQ-ACK information for the plurality of pieces of downlink data and transmits the bundled HARQ-ACK information on the determined second resource or resource pair.

14. The method of claim 12, wherein the second resource or resource pair for transmitting the HARQ-ACK information is determined based on a predetermined rule.

15. The method of claim 12, wherein the second resource or resource pair for transmitting the HARQ-ACK information is selected from a set of resources for transmitting the HARQ-ACK information.

16. A user equipment in a wireless communication system, the user equipment comprising:
a memory in which instructions are stored; and
a processor configured to execute the instructions to implement the method of claim 1.

17. A base station in a wireless communication system, the base station comprising:
a memory in which instructions are stored; and
a processor configured to execute the instructions to implement the method of claim 12.
